(19) United States
(12) Patent Application Publication
(10) Pub. No.: US 2024/0048340 A1
(43) Pub. Date: Feb. 8, 2024

(54) SYSTEMS AND METHODS FOR INDICATING TCI STATES UNDER MULTI-TRP OPERATION

(71) Applicant: ZTE CORPORATION, Shenzhen (CN)

(72) Inventors: Yang ZHANG, Shenzhen (CN); Shujuan ZHANG, Shenzhen (CN); Zhaohua LU, Shenzhen (CN); Chuangxin JIANG, Shenzhen (CN); Ke YAO, Shenzhen (CN); Bo GAO, Shenzhen (CN)

(73) Assignee: ZTE CORPORATION, Shenzhen (CN)

(21) Appl. No.: 18/490,021

(22) Filed: Oct. 19, 2023

Related U.S. Application Data
(63) Continuation of application No. PCT/CN2021/122018, filed on Sep. 30, 2021.

(51) Int. Cl. H04L 5/00

(52) U.S. Cl. CPC H04L 5/0091; H04L 5/0035

(57) ABSTRACT

Example implementations can include a wireless communication method of receiving, by a wireless communication device from a wireless communication node, a first message including a control element that selectively includes a field having an indicator or a field having an index, determining, by the wireless communication device, a configured operative status of each of one or more Transmission Configuration Indicator (TCI) states for a downlink communication, according to the control element. Example implementations can include a wireless communication method of sending, by a wireless communication node to a wireless communication device, a first message including a control element, and sending, by the wireless communication node to the wireless communication device, a downlink communication, where the control element can be used by the wireless communication device to determine a configured operative status of each of one or more Transmission Configuration Indicator (TCI) states for the downlink communication.

### CROSS-REFERENCE TO RELATED APPLICATION

This application claims the benefit of priority under 35 U.S.C. § 120 as a continuation of PCT Patent Application No. PCT/CN2021/122018, filed on Sep. 30, 2021, the disclosure of which is incorporated herein by reference in its entirety.

### TECHNICAL FIELD

The present implementations relate generally to wireless communications, and more particularly to indicating TCI states under multi-TRP operation.

### BACKGROUND

In conventional systems, multi-downlink control information (DCI) based physical downlink shared channel (PDSCH) multiple transmission and reception (MTRP) can be not supported beyond intra-cell deployment. Thus, downlink receptions from multiple TRPs must belong to one cell. To further enhance the flexibility for scheduling and improve the reliability for downlink receptions, multi-DCI based inter-cell (multiple cells) MTRP operation can be not available and can be desired. Receiving downlink signals/RSs from serving-cell TRP and non-serving cell TRP, including a cell having TRP with different physical cell identifiers (PCIs) from a serving cell, can be also desired. Accordingly, conventional system cannot determine beam (TCI state) indication for the downlink receptions from non-serving cell TRP.

### SUMMARY

A technological solution for indicating TCI states under multi-TRP operation can be provided. Example implementations can include a wireless communication method of receiving, by a wireless communication device from a wireless communication node, a first message including a control element that selectively includes a field having an indicator or a field having an index, determining, by the wireless communication device, a configured operative status of each of one or more Transmission Configuration Indicator (TCI) states for a downlink communication, according to the control element.

Example implementations can include a method where the downlink communication includes at least one of a Physical Downlink Shared Channel (PDSCH) reception, a Physical Downlink Control Channel (PDCCH) reception, a Physical Downlink Shared Channel (PDSCH) reception, a Semi-Persistent (SP) Channel State Information Reference Signal (CSI-RS), a Semi-Persistent (SP) Channel State Information Interference Measurement (CSI-IM), or an aperiodic Channel State Information Reference Signal (CSI-RS).

Example implementations can include a method of identifying, by the wireless communication device, the control element from the first message based on at least one of a Medium Access Control (MAC) subheader or an Extended Logic Channel Indicator (eLCID).

Example implementations can include a method where the control element includes a first field indicating an identity of a Serving Cell to which the control element applies.

Example implementations can include a method where the control element includes a second field indicating a Bandwidth Part Indicator (BWP ID).

Example implementations can include a method where the control element includes one or more third fields respectively indicating the operative statuses of the TCI states.

Example implementations can include a method where the one or more third fields form a bitmap.

Example implementations can include a method where the one or more third fields form one or more codepoints.

Example implementations can include a method where the control element selectively includes a fourth field indicating a Control Resource Set Pool Indicator (CORESET Pool ID).

Example implementations can include a method where the control element selectively includes a fifth field having an index indicating a single non-serving cell information unit with which a subset of the one or more TCI states, being activated, can be associated.

Example implementations can include a method of claim 10, where the non-serving cell information unit can be associated with a cell configured with a different Physical Cell Indicator (PCI) from a serving cell.

Example implementations can include a method of including receiving, by the wireless communication device, second message including a Radio Resource Control (RRC) signaling that configures the single non-serving cell information unit, where the non-serving cell information unit can be specific to a Synchronization Signal Block (SSB) of an RRC Information Element (IE).

Example implementations can include a method where the index further indicates a PCI additional to a PCI of a serving cell and associated with the single non-serving cell information unit.

Example implementations can include a method where the fifth field can be present in the control element when the non-serving cell information unit can be configured with the index, and where the fifth field can be specific to the configured index in the non-serving cell information unit.

Example implementations can include a method where a number of the activated TCI states associated with the non-serving cell information unit corresponds to the additional PCI, and depend based on User Equipment (UE) capability of the wireless communication device.

Example implementations can include a method where the control element selectively includes a sixth field having an indicator indicating whether the one or more TCI states, being activated, can be associated with a single non-serving cell information unit.

Example implementations can include a method where the sixth field essentially consists of 1 bit with either a first value or a second value.

Example implementations can include a method where the first value represents that the activated TCI states can be configured in a serving cell, and the second value represents that the activated TCI states can be associated with the non-serving cell information unit.

Example implementations can include a method where the sixth field can be present in the control element only when the activated TCI states can be associated with the non-serving cell information unit.

Example implementations can include a method where the sixth field can be specific to the indicator configured for one or more reference signals specified in an RRC IE.

Example implementations can include a method where the control element selectively includes a sixth field indicates that the activated TCI states respectively correspond to indicators of one or more reference signals specified in an RRC IE.

Example implementations can include a method of claim 21, where the reference signals can be each a Synchronization Signal Block (SSB) or Channel State Information Reference Signal (CSI-RS).

Example implementations can include a method where the indicators configured for the one or more reference signals correspond to the sixth field.

Example implementations can include a wireless communication method of sending, by a wireless communication node to a wireless communication device, a first message including a control element, and sending, by the wireless communication node to the wireless communication device, a downlink communication, where the control element can be used by the wireless communication device to determine a configured operative status of each of one or more Transmission Configuration Indicator (TCI) states for the downlink communication.

Example implementations can include a wireless communication apparatus including at least one processor and a memory, where the at least one processor can be configured to read code from the memory and implement a method at least according to present implementations.

Example implementations can include a computer program product including a computer-readable program medium code stored thereupon, the code, when executed by at least one processor, cause the at least one processor to implement s method at least according to present implementations.

### BRIEF DESCRIPTION OF THE DRAWINGS

These and other aspects and features of the present implementations will become apparent to those ordinarily skilled in the art upon review of the following description of specific implementations in conjunction with the accompanying figures, wherein:

FIG. 1 illustrates an example cellular communication network in which techniques and other aspects disclosed herein may be implemented, in accordance with an implementation of the present disclosure.

FIG. 2 illustrates block diagrams of an example base station and a user equipment device, in accordance with some implementations of the present disclosure.

FIG. 3 illustrates a system in accordance with present implementations.

FIG. 4 illustrates a first state indication, in accordance with present implementations.

FIG. 5 illustrates a second state indication, in accordance with present implementations.

FIG. 6 illustrates a third state indication, in accordance with present implementations.

FIG. 7 illustrates a signaling structure in accordance with present implementations.

FIG. 8 illustrates a fourth state indication, in accordance with present implementations.

FIG. 9 illustrates a fifth state indication, in accordance with present implementations.

FIG. 10 illustrates a sixth state indication, in accordance with present implementations.

FIG. 11 illustrates a seventh state indication, in accordance with present implementations.

FIG. 12 illustrates a first method of indicating TCI states under multi-TRP operation, in accordance with present implementations.

FIG. 13 illustrates a second method of indicating TCI states under multi-TRP operation, further to the method of FIG. 13.

FIG. 14 illustrates a third method of indicating TCI states under multi-TRP operation, in accordance with present implementations.

FIG. 15 illustrates a fourth method of indicating TCI states under multi-TRP operation, in accordance with present implementations.

FIG. 16 illustrates a fifth method of indicating TCI states under multi-TRP operation, in accordance with present implementations.

### DETAILED DESCRIPTION

The present implementations will now be described in detail with reference to the drawings, which can be provided as illustrative examples of the implementations so as to enable those skilled in the art to practice the implementations and alternatives apparent to those skilled in the art. Notably, the figures and examples below can be not meant to limit the scope of the present implementations to a single implementation, but other implementations can be possible by way of interchange of some or all of the described or illustrated elements. Moreover, where certain elements of the present implementations can be partially or fully implemented using known components, only those portions of such known components that can be necessary for an understanding of the present implementations will be described, and detailed descriptions of other portions of such known components will be omitted so as not to obscure the present implementations. Implementations described as being implemented in software should not be limited thereto, but can include implementations implemented in hardware, or combinations of software and hardware, and vice-versa, as will be apparent to those skilled in the art, unless otherwise specified herein. In the present specification, an implementation showing a singular component should not be considered limiting; rather, the present disclosure can be intended to encompass other implementations including a plurality of the same component, and vice-versa, unless explicitly stated otherwise herein. Moreover, applicants do not intend for any term in the specification or claims to be ascribed an uncommon or special meaning unless explicitly set forth as such. Further, the present implementations encompass present and future known equivalents to the known components referred to herein by way of illustration.

In general, a communication protocol can include a number of MIMO features that facilitate utilization of a large number of antenna elements at base station for both sub-6 GHz (Frequency Range 1, FR1) and over-6 GHz (Frequency Range 2, FR2) frequency bands. MIMO features can support multi-TRP operation. Multiple TRPs can collaborate to transmit data to the UE to improve transmission performance. In a communication protocol, the beam indication for downlink signals/RSs with multi-DCI based MTRP operation can include multi-step signaling, which involves higher layer signaling and physical-layer signaling, to reduce the signaling overhead as well as ensure the flexibility of beam indication. The beam indication can include a TCI state indication or QCL assumption. The specific parameters of QCL can be included in radio resource control (RRC) IE TCI-state as follows.

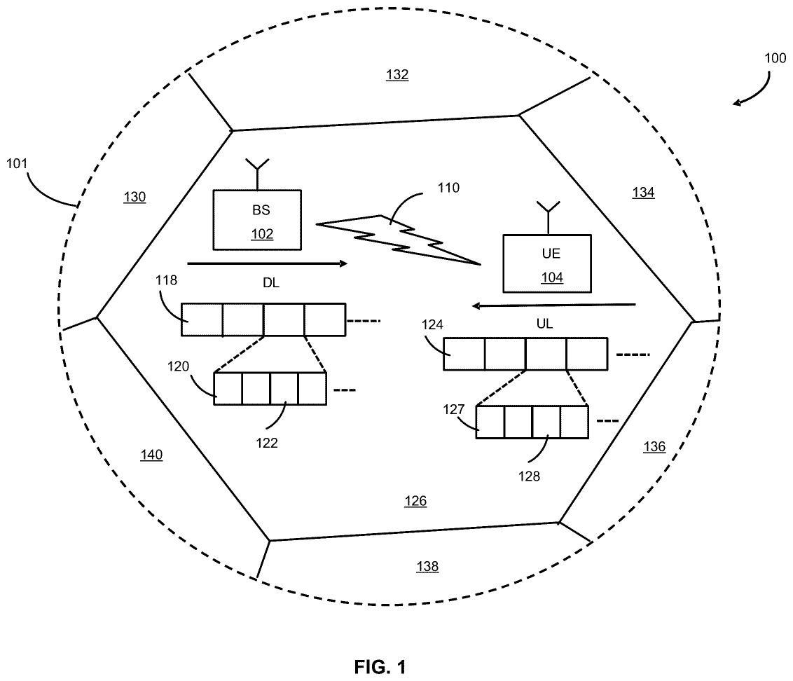

FIG. 1 illustrates an example wireless communication network, and/or system, 100 in which techniques disclosed herein may be implemented, in accordance with an implementation of the present disclosure. In the following discussion, the wireless communication network 100 may be any wireless network, such as a cellular network or a narrowband Internet of things (NB-IoT) network, and can be herein referred to as “network 100.” Such an example network 100 includes a base station 102 (hereinafter “BS 102”) and a user equipment device 104 (hereinafter “UE 104”) that can communicate with each other via a communication link 110 (e.g., a wireless communication channel), and a cluster of cells 126, 130, 132, 134, 136, 138 and 140 overlaying a geographical area 101. In FIG. 1, the BS 102 and UE 104 can be contained within a respective geographic boundary of cell 126. Each of the other cells 130, 132, 134, 136, 138 and 140 may include at least one base station operating at its allocated bandwidth to provide adequate radio coverage to its intended users.

For example, the BS 102 may operate at an allocated channel transmission bandwidth to provide adequate coverage to the UE 104. The BS 102 and the UE 104 may communicate via a downlink radio frame 118, and an uplink radio frame 124 respectively. Each radio frame 118/124 may be further divided into sub-frames 120/127 which may include data symbols 122/128. In the present disclosure, the BS 102 and UE 104 can be described herein as non-limiting examples of “communication nodes,” generally, which can practice the methods disclosed herein. Such communication nodes may be capable of wireless and/or wired communications, in accordance with various implementations of the present solution.

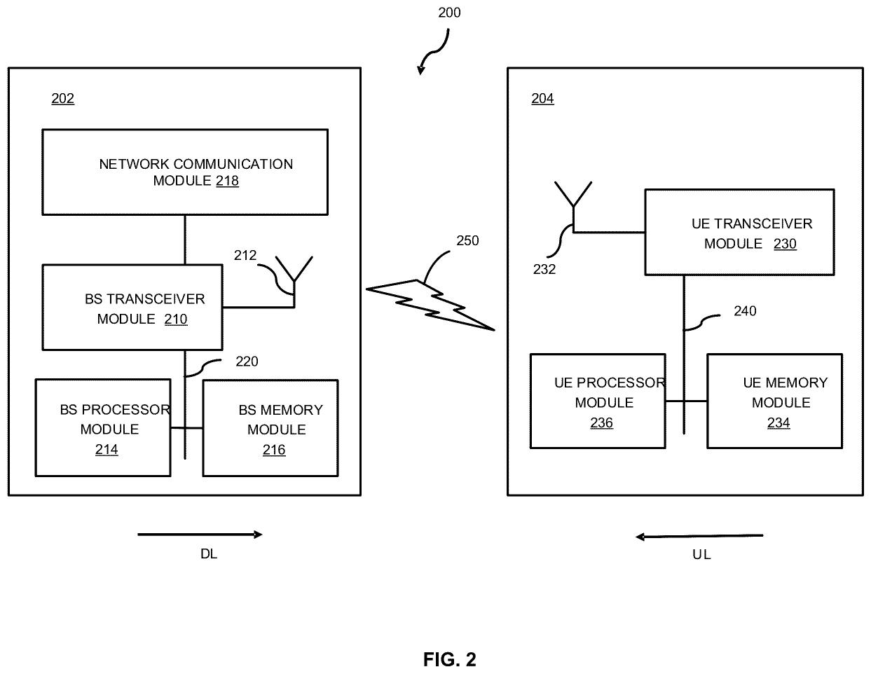

FIG. 2 illustrates a block diagram of an example wireless communication system 200 for transmitting and receiving wireless communication signals, e.g., OFDM/OFDMA signals, in accordance with some implementations of the present solution. The system 200 may include components and elements configured to support known or conventional operating features that need not be described in detail herein. In one illustrative implementation, system 200 can be used to communicate (e.g., transmit and receive) data symbols in a wireless communication environment such as the wireless communication environment 100 of FIG. 1, as described above.

System 200 generally includes a base station 202 (hereinafter “BS 202”) and a user equipment device 204 (hereinafter “UE 204”). The BS 202 includes a BS (base station) transceiver module 210, a BS antenna 212, a BS processor module 214, a BS memory module 216, and a network communication module 218, each module being coupled and interconnected with one another as necessary via a data communication bus 220. The UE 204 includes a UE (user equipment) transceiver module 230, a UE antenna 232, a UE memory module 234, and a UE processor module 236, each module being coupled and interconnected with one another as necessary via a data communication bus 240. The BS 202 communicates with the UE 204 via a communication channel 250, which can be any wireless channel or other medium suitable for transmission of data as described herein.

As would be understood by persons of ordinary skill in the art, system 200 may further include any number of modules other than the modules shown in FIG. 2. Those skilled in the art will understand that the various illustrative blocks, modules, circuits, and processing logic described in connection with the implementations disclosed herein may be implemented in hardware, computer-readable software, firmware, or any practical combination thereof. To clearly illustrate this interchangeability and compatibility of hardware, firmware, and software, various illustrative components, blocks, modules, circuits, and steps can be described generally in terms of their functionality. Whether such functionality can be implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure.

In accordance with some implementations, the UE transceiver 230 may be referred to herein as an “uplink” transceiver 230 that includes a radio frequency (RF) transmitter and a RF receiver each comprising circuitry that can be coupled to the antenna 232. A duplex switch (not shown) may alternatively couple the uplink transmitter or receiver to the uplink antenna in time duplex fashion. Similarly, in accordance with some implementations, the BS transceiver 210 may be referred to herein as a “downlink” transceiver 210 that includes a RF transmitter and a RF receiver each comprising circuitry that can be coupled to the antenna 212. A downlink duplex switch may alternatively couple the downlink transmitter or receiver to the downlink antenna 212 in time duplex fashion. The operations of the two transceiver modules 210 and 230 can be coordinated in time such that the uplink receiver circuitry can be coupled to the uplink antenna 232 for reception of transmissions over the wireless transmission link 250 at the same time that the downlink transmitter can be coupled to the downlink antenna 212. In some implementations, there can be close time synchronization with a minimal guard time between changes in duplex direction.

The UE transceiver 230 and the base station transceiver 210 can be configured to communicate via the wireless data communication link 250, and cooperate with a suitably configured RF antenna arrangement 212/232 that can support a particular wireless communication protocol and modulation scheme. In some illustrative implementations, the UE transceiver 210 and the base station transceiver 210 can be configured to support industry standards such as the Long Term Evolution (LTE) and emerging 5G standards, and the like. It can be understood, however, that the present disclosure can be not necessarily limited in application to a particular standard and associated protocols. Rather, the UE transceiver 230 and the base station transceiver 210 may be configured to support alternate, or additional, wireless data communication protocols, including future standards or variations thereof.

In accordance with various implementations, the BS 202 may be an evolved node B (eNB), a serving eNB, a target eNB, a femto station, or a pico station, for example. In some implementations, the UE 204 may be embodied in various types of user devices such as a mobile phone, a smart phone, a personal digital assistant (PDA), tablet, laptop computer, wearable computing device, etc. The processor modules 214 and 236 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the implementations disclosed herein may be embodied directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 210 and 230, respectively, such that the processors modules 210 and 230 can read information from, and write information to, memory modules 216 and 234, respectively. The memory modules 216 and 234 may also be integrated into their respective processor modules 210 and 230. In some implementations, the memory modules 216 and 234 may each include a cache memory for storing temporary variables or other intermediate information during execution of instructions to be executed by processor modules 210 and 230, respectively. Memory modules 216 and 234 may also each include non-volatile memory for storing instructions to be executed by the processor modules 210 and 230, respectively.

The network communication module 218 generally represents the hardware, software, firmware, processing logic, and/or other components of the base station 202 that enable bi-directional communication between base station transceiver 210 and other network components and communication nodes configured to communication with the base station 202. For example, network communication module 218 may be configured to support internet or WiMAX traffic. In a typical deployment, without limitation, network communication module 218 provides an 802.3 Ethernet interface such that base station transceiver 210 can communicate with a conventional Ethernet based computer network. In this manner, the network communication module 218 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that can be physically constructed, programmed, formatted and/or arranged to perform the specified operation or function.

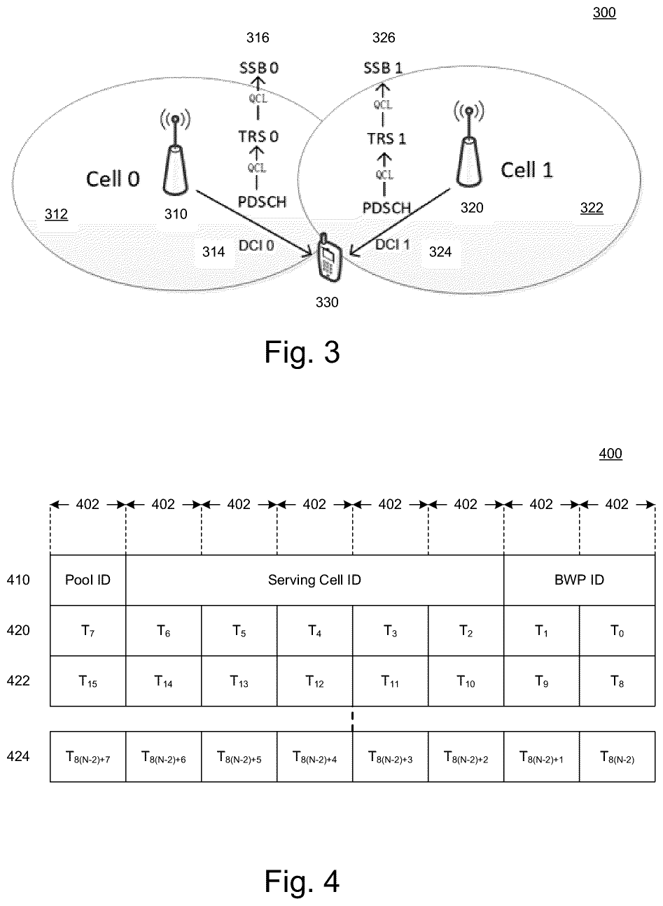

FIG. 3 illustrates a system in accordance with present implementations. As illustrated by way of example in FIG. 3, an example system can include a first BS 310, a second BS 320, and a UE 330. The first BS 310 can have a communication range 312, and can transmit a first downlink control information (DCI 0) 314 by one or more operating states 316. The second BS 310 can have a communication range 322, and can transmit a second downlink control information (DCI 1) 324 by one or more operating states 326.

FIG. 4 illustrates a first state indication, in accordance with present implementations. As illustrated by way of example in FIG. 4, an example state indication 400 can include an octet structure 402, an identifier octet 410, a first TCI state octet 420, a second TCI state octet 422, and a third TCI state octet 424. It is to be understood that the number of TCI state octets can be greater than or less than the number illustrated by way of example herein.

For PDSCH, the TCI state indication can be jointly determined by RRC, MAC CE and DCI by the following three-step manner. Step 1 can include TCI state configuration or reconfiguration. Here, the RRC parameters tci-StatesToAddModList and tci-StatesToReleaseList in PDSCH-Config can be jointly used to configure up to 128 TCI states as candidate. Step 2 can include TCI state activation or reactivation. Here, the TCI States Activation or deactivation for UE-specific PDSCH MAC CE can be used to select up to 8 TCI states from the RRC-configured TCI states. Wherein, the field of CORESET Pool ID can be used to indicate that mapping between the activated TCI states and the codepoint of the DCI Transmission Configuration Indication set by field Tᵢ can be specific to the RRC parameter ControlResourceSetId configured with CORESET Pool ID in RRC IE ControlResourceSet. More specifically, one value of CORESET Pool ID corresponds to one TRP. Step 3 can include TCI state indication. Here, the field of “transmission configuration indication” in DCI can be used to indicate one TCI state from the MAC CE-activated TCI states.

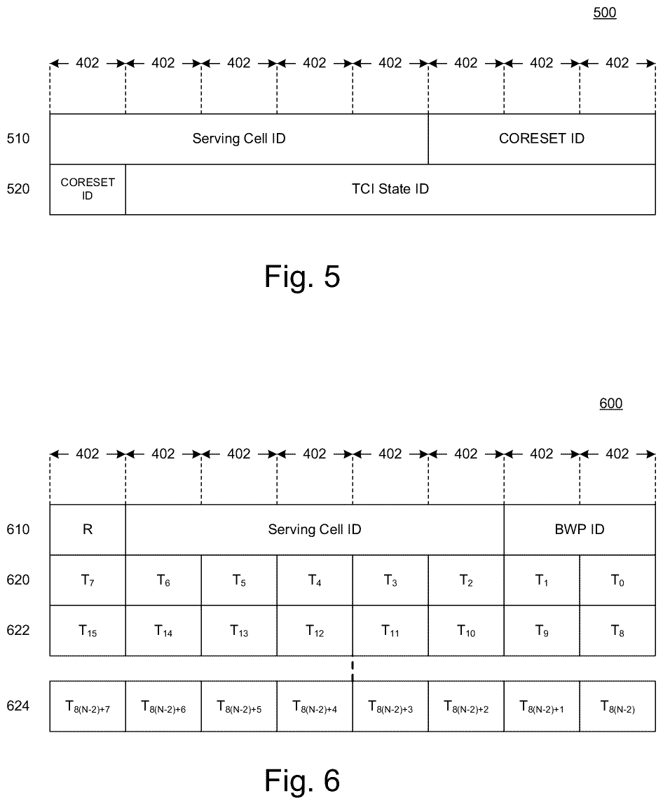

FIG. 5 illustrates a second state indication, in accordance with present implementations. As illustrated by way of example in FIG. 5, an example state indication 500 can include the octet structure 402, a first identifier octet 510 and a second identifier octet 520.

For a physical downlink control channel (PDCCH), the TCI state indication can be jointly determined by RRC and MAC CE by the following two-step manner. Step 1 can include a TCI state configuration or reconfiguration. Here, when ControlResourceSetId or ControlResourceSetId-r16 is 0, the RRC parameters tci-States-ToAddModList and tci-States-ToReleaseList in PDSCH-Config can be jointly used to configure up to the first 64 TCI states as candidates. Otherwise, the RRC parameters tci-StatesPDCCH-ToAddList and tci-StatesPDCCH-ToReleaseList in ControlResourceSet can be jointly used to configure up to 64 TCI states as candidates. One value of RRC parameter coresetPoollndex-r16 can correspond to one TRP. Step 2 can include a TCI state indication. Here, one or more TCI states can be activated or deactivated from the RRC-configured TCI states by MAC CE, and can correspond to one CORESET for the PDCCH towards one TRP.

For SP channel state information reference signal (CSI-RS) or channel state information interference measurement (CSI-IM), the TCI state indication can be determined by MAC CE by the following one-step manner. Step 1 can include aTCI state indication. Here, at least one TCI state can be indicated from the RRC-configured TCI states by MAC CE, which can be used as QCL source for the resource within the Semi Persistent NZP CSI-RS resource set indicated by SP CSI-RS resource set ID field.

FIG. 6 illustrates a third state indication, in accordance with present implementations. As illustrated by way of example in FIG. 6, an example state indication 600 can include a first configuration octet 610, a first TCI state octet 620, a second TCI state octet 622, and a third TCI state octet 624. It is to be understood that the number of TCI state octets can be greater than or less than the number illustrated by way of example herein.

For aperiodic CSI-RS, the TCI state indication of the indicated aperiodic CSI Trigger State can be jointly determined by RRC, MAC CE and DCI by the following three-step manner. Step 1 can include TCI state configuration or reconfiguration. Here, the RRC parameter CSI-AperiodicTriggerStateList can be used to configure up to 128 Trigger States as candidate. Step 2 can include TCI state activation or reactivation. Here, the Aperiodic CSI Trigger State Subselection MAC CE can be used to select up to 63 Aperiodic CSI Trigger States from the RRC-configured parameter aperiodicTriggerStateList. Step 3 can include a TCI state indication. Here, the field of “CSI request” in DCI can be used to indicate one TCI state of one Aperiodic CSI Trigger State from the MAC CE-activated TCI states.

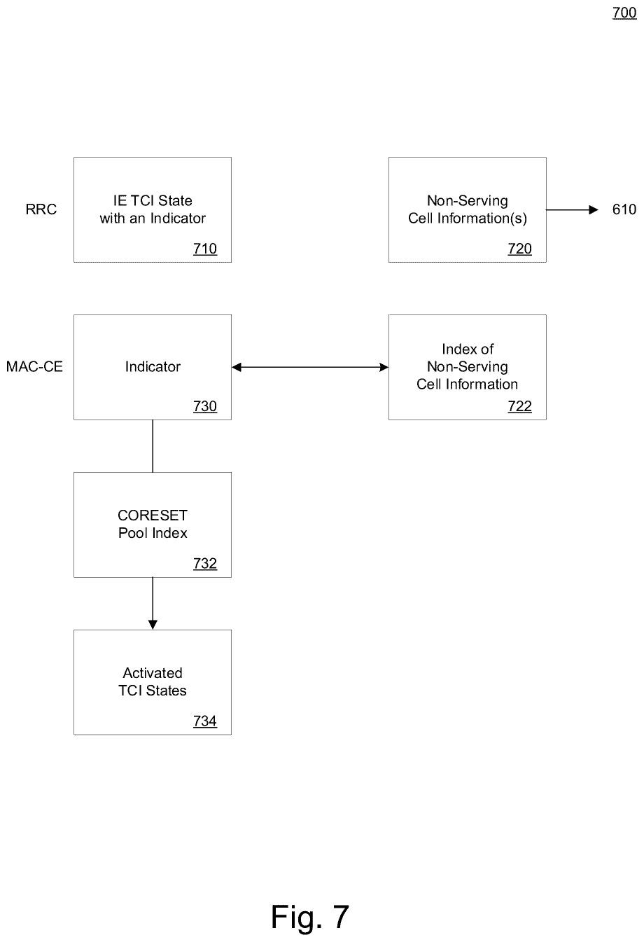

FIG. 7 illustrates a signaling structure in accordance with present implementations. As illustrated by way of example in FIG. 7, an example signaling structure 700 can include an IE TCI state with an indicator 710, at least one non-serving cell information 720, a configuration output 722 of the non-serving cell information 720, an index of the non-serving cell information 724, an indicator 730, a CORESET pool index 732, and one or more activated TCI states. The IE TCI state with an indicator 710 can be associated with an RRC. The indicator 730 can be associated with a MAC-CE. The configuration output 722 can include a new IE, where the new IE can have a structure including an index, at least one additional PCI, and at least one SSB configuration.

In some embodiments, the UE receives a MAC CE to determine the activation or deactivation status of the TCI state(s) for a downlink reception. Where the UE receives a MAC CE to determine the activation or deactivation status of the TCI state(s) for a downlink reception, the downlink reception can be PDSCH. Where the UE receives a MAC CE to determine the activation or deactivation status of the TCI state(s) for a downlink reception, the MAC CE can be identified by a MAC subheader with LCID or eLCID.

Where the UE receives a MAC CE to determine the activation or deactivation status of the TCI state(s) for a downlink reception, the MAC CE may include a field of the Serving Cell ID. Here, the Serving Cell ID can indicate the identity of the Serving Cell for which the MAC CE applies.

Where the UE receives a MAC CE to determine the activation or deactivation status of the TCI state(s) for a downlink reception, the MAC CE may include a field of the BWP ID. Here, the BWP ID field can indicate a DL BWP for which the MAC CE applies as the codepoint of the DCI bandwidth part indicator field. The length of the BWP ID field can be 2 bits. This field can be ignored if this MAC CE applies to a set of Serving Cells.

Where the UE receives a MAC CE to determine the activation or deactivation status of the TCI state(s) for a downlink reception, the MAC CE may include one or multiple fields that indicate the activation or deactivation status of the TCI state which configured by the RRC parameter TCI-StateId i. Here, the one or multiple fields can be a bitmap and each field can be denoted as “Tᵢ”. Here, the length of each Tᵢ field can be 1 bit and its value is set to 0 or 1. The Tᵢ field can be set to 1 to indicate that the TCI state with TCI-StateId i shall be activated and mapped to the codepoint of the DCI Transmission Configuration Indication field, the Tᵢ field is set to 0 to indicate that the TCI state with TCI-StateId i shall be deactivated and can be not mapped to the codepoint of the DCI Transmission Configuration Indication field. The codepoint of the DCI Transmission Configuration Indication field to which the TCI State can be mapped can be determined by its ordinal position among all the TCI States with Tᵢ field set to 1, i.e. the first TCI State with Tᵢ field set to 1 shall be mapped to the codepoint value 0, second TCI State with Tᵢ field set to 1 shall be mapped to the codepoint value 1 and so on. The maximum number of activated TCI states can be 8. Here, the number of the fields can be variable and may depend on the RRC parameters tci-StatesToAddModList and tci-StatesToReleaseList in PDSCH-Config plus the configured indicator of the reference signal in RRC IE TCI-State. Here, the one or multiple fields can be one or multiple codepoints, and each field can be denoted as “TCI State ID”.

Here, the length of each TCI State ID field can be 7 bits, and its value can be any integer from 0 to 127. The value i of the TCI State ID field indicates that the TCI state with TCI-StateId i shall be activated and mapped to the codepoint of the DCI Transmission Configuration Indication field. The codepoint of the DCI Transmission Configuration Indication field to which the TCI State can be mapped can be determined by its ordinal position among all the TCI States activated by the TCI State ID field, i.e. the first TCI State with the lowest TCI State ID shall be mapped to the codepoint value 0, second TCI State with the second lowest TCI State ID shall be mapped to the codepoint value 1 and so on. The maximum number of activated TCI states can be 8. Here, the number of the fields can be variable and may depend on the RRC parameters tci-StatesToAddModList and tci-StatesToReleaseList in PDSCH-Config plus the configured indicator of the reference signal in RRC IE TCI-State.

Where the UE receives a MAC CE to determine the activation or deactivation status of the TCI state(s) for a downlink reception, the MAC CE may include a field of the CORESET Pool ID. Here, the CORESET Pool ID field indicates the mapping between the activated TCI states and the codepoint of the DCI Transmission Configuration Indication set by the Tᵢ or TCI State ID field can be specific to the associated ControlResourceSetId configured with CORESET Pool ID.

Where the UE receives a MAC CE to determine the activation or deactivation status of the TCI state(s) for a downlink reception, the MAC CE may include a field of an index. Here, the index field indicates the non-serving cell information that the activated TCI states can be associated with. The non-serving cell can be the cell with different PCI from the serving cell. The non-serving cell information can be configured by RRC and can be specified to the SSB in RRC IE TCI-State, which at least includes one of: an index, an additional PCI different from the serving cell PCI, SSB time domain position, SSB transmission periodicity, or SSB transmission power. Here, the configured index indicates a non-serving cell information with an additional PCI. The maximum number of the non-serving cell information can be configured by RRC and depends on a reported UE capability. Here, if the UE reports the capability parameter of the maximum number, it means the UE can support inter-cell MTRP operation. If the UE does not report the capability parameter of the maximum number, it means the UE cannot support inter-cell MTRP operation.

Further, only one non-serving cell information can be configured by RRC. Here, if the non-serving cell information is not configured with the index, the index field in the MAC CE can be not present. Here, if the non-serving cell information configured with the index, the index field in the MAC CE can be specific to the configured index in the non-serving cell information. For example, the value of the index field in the MAC CE can be the same as the configured index in the non-serving cell information. The number of the configured TCI states associated with the non-serving cell information can be dedicated to the additional PCI and depends on the reported UE capability.

Where the UE receives a MAC CE to determine the activation or deactivation status of the TCI state(s) for a downlink reception, the MAC CE may include a field of an indicator. Here, the indicator field may indicate whether the activated TCI states can be associated with the non-serving cell information. Further, the length of the indicator field can be 1 bit, and it is set to 0 or 1. Here, the indicator field set to one value of 0 or 1 indicates that the activated TCI states can be configured in the serving cell, the indicator field set to another value indicates that the activated TCI states can be associated with the non-serving cell information. Here, the indicator field may be present only when the activated TCI states can be associated with the non-serving cell information. Here, the indicator field in the MAC CE can be specific to the configured indicator of the reference signal in RRC IE TCI-State. For example, the indicator field in the MAC CE can be the same as or equal to the configured indicator.

Where the UE receives a MAC CE to determine the activation or deactivation status of the TCI state(s) for a downlink reception, the indicator field may indicate that the activated TCI state(s) identified by the configured indicator of the reference signal in RRC IE TCI-State. Here, the reference signal can be SSB or CSI-RS. Further, the configured indicator can indicate that the TCI-State can be associated with an additional PCI of a non-serving cell information or a serving cell PCI. Further, the number of the configured non-serving cell information can be 1. Here, the indicator field in the MAC CE can be the same as or equal to the configured indicator of the reference signal in RRC IE TCI-State. The indicator field in the MAC CE may be present only when the activated TCI states can be associated with a non-serving cell information.

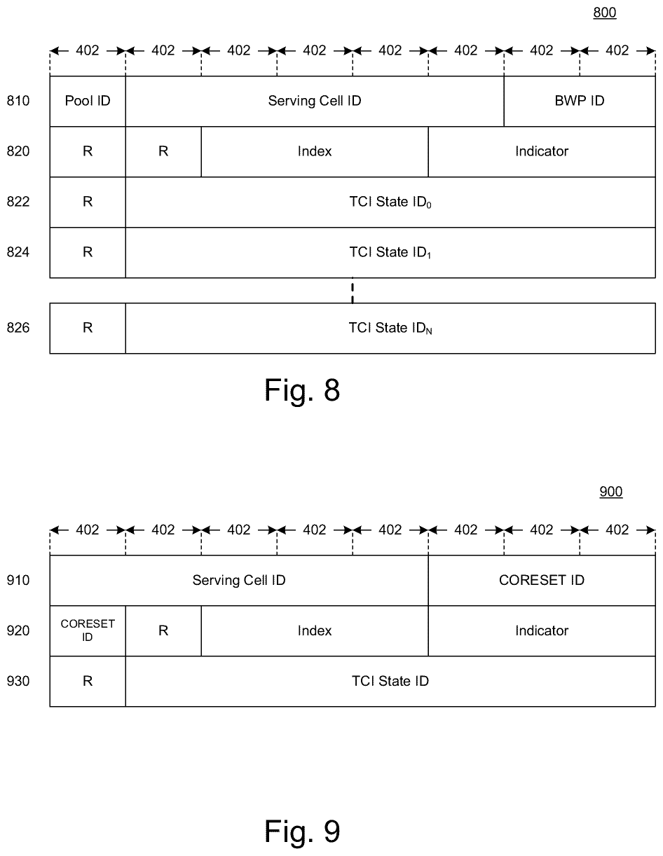

FIG. 8 illustrates a fourth state indication, in accordance with present implementations. As illustrated by way of example in FIG. 8, an example state indication 800 can include an identifier octet 810, a configuration octet 820, a first TCI state identifier octet 830, a second TCI state identifier octet 832, and a third TCI state identifier octet 834. It is to be understood that the number of TCI state identifier octets can be greater than or less than the number illustrated by way of example herein.

In some embodiments, the UE receives a MAC CE to determine the activation or deactivation status of the TCI state(s) for a downlink reception. Where the UE receives a MAC CE to determine the activation or deactivation status of the TCI state(s) for a downlink reception, the downlink reception can be PDSCH. Where the UE receives a MAC CE to determine the activation or deactivation status of the TCI state(s) for a downlink reception, the MAC CE can be identified by a MAC subheader with LCID or eLCID.

Where the UE receives a MAC CE to determine the activation or deactivation status of the TCI state(s) for a downlink reception, the MAC CE may include a field of the Serving Cell ID. Here, the Serving Cell ID indicates the identity of the Serving Cell for which the MAC CE applies.

Where the UE receives a MAC CE to determine the activation or deactivation status of the TCI state(s) for a downlink reception, the MAC CE may include a field of the BWP ID. Here, the BWP ID field indicates a DL BWP for which the MAC CE applies as the codepoint of the DCI bandwidth part indicator field. The length of the BWP ID field can be 2 bits. This field can be ignored if this MAC CE applies to a set of Serving Cells.

Where the UE receives a MAC CE to determine the activation or deactivation status of the TCI state(s) for a downlink reception, the MAC CE may include one or multiple fields that indicate the activation or deactivation status of the TCI state which configured by the RRC parameter TCI-StateId i. Here, the one or multiple fields can be a bitmap and each field can be denoted as “Tᵢ”. Here, the length of each Tᵢ field can be 1 bit and its value is set to 0 or 1. The Tᵢ field can be set to 1 to indicate that the TCI state with TCI-StateId i shall be activated and mapped to the codepoint of the DCI Transmission Configuration Indication field, the Tᵢ field is set to 0 to indicate that the TCI state with TCI-StateId i shall be deactivated and can be not mapped to the codepoint of the DCI Transmission Configuration Indication field. The codepoint of the DCI Transmission Configuration Indication field to which the TCI State can be mapped can be determined by its ordinal position among all the TCI States with Tᵢ field set to 1, i.e. the first TCI State with Tᵢ field set to 1 shall be mapped to the codepoint value 0, second TCI State with Tᵢ field set to 1 shall be mapped to the codepoint value 1 and so on. The maximum number of activated TCI states can be 8. Here, the number of the fields can be variable and may depend on the RRC parameters tci-StatesToAddModList and tci-StatesToReleaseList in PDSCH-Config plus the configured indicator of the reference signal in RRC IE TCI-State.

Further, the one or multiple fields can be one or multiple codepoints, and each field can be denoted as “TCI State ID”. Here, the length of each TCI State ID field can be 7 bits, and its value can be any integer from 0 to 127. The value i of the TCI State ID field indicates that the TCI state with TCI-StateId i shall be activated and mapped to the codepoint of the DCI Transmission Configuration Indication field. The codepoint of the DCI Transmission Configuration Indication field to which the TCI State can be mapped can be determined by its ordinal position among all the TCI States activated by the TCI State ID field, i.e. the first TCI State with the lowest TCI State ID shall be mapped to the codepoint value 0, second TCI State with the second lowest TCI State ID shall be mapped to the codepoint value 1 and so on. The maximum number of activated TCI states can be 8. The number of the fields can be variable and may depend on the RRC parameters tci-StatesToAddModList and tci-StatesToReleaseList in PDSCH-Config plus the configured indicator of the reference signal in RRC IE TCI-State.

Where the UE receives a MAC CE to determine the activation or deactivation status of the TCI state(s) for a downlink reception, the MAC CE may include a field of the CORESET Pool ID. Here, the CORESET Pool ID field indicates the mapping between the activated TCI states and the codepoint of the DCI Transmission Configuration Indication set by the Tᵢ or TCI State ID field can be specific to the associated ControlResourceSetId configured with CORESET Pool ID.

Where the UE receives a MAC CE to determine the activation or deactivation status of the TCI state(s) for a downlink reception, the MAC CE may include a field of an index. Further, the index field can indicate the non-serving cell information that the activated TCI states can be associated with. Here, the non-serving cell can be the cell with different PCI from the serving cell.

Further, the non-serving cell information can be determined by RRC configuration and can be specified to the SSB in RRC IE TCI-State, which at least includes one of: an index, an additional PCI different from the serving cell PCI, SSB time domain position, SSB transmission periodicity, or SSB transmission power. Here, the maximum number of the additional PCI of a non-serving cell information can be configured by RRC and depends on a reported UE capability. Here, if the UE reports the capability parameter of the maximum number, it means the UE can support inter-cell MTRP operation. If the UE does not report the capability parameter of the maximum number, it means the UE cannot support inter-cell MTRP operation. More than one additional PCI of a non-serving cell information can be configured by RRC.

If the non-serving cell information is not configured with the index, the value of the index field in the MAC CE can be determined by the order of the additional PCI of the multiple non-serving cell information. For example, the value 0 of the index field in the MAC CE corresponds to the lowest additional PCI of the non-serving cell information, the value 1 of the index field in the MAC CE corresponds to the second lowest additional PCI of the non-serving cell information, and so on. For example, the value 0 of the index field in the MAC CE indicates the serving cell PCI, the value 1 of the index field in the MAC CE indicates the lowest additional PCI of the non-serving cell information, the value 2 of the index field in the MAC CE indicates the second lowest additional PCI of the non-serving cell information, and so on.

If the non-serving cell information configured with the index, the index field in the MAC CE can be specific to the configured index in the non-serving cell information. For example, the value of the index field in the MAC CE can be the same as the configured index in the non-serving cell information. For example, the value of the index field in the MAC CE can be equal to the value of the configured index in the non-serving cell information plus 1. Here, the number of the configured TCI states associated with the non-serving cell information can be dedicated to one additional PCI and depends on the reported UE capability.

Where the UE receives a MAC CE to determine the activation or deactivation status of the TCI state(s) for a downlink reception, the MAC CE may include a field of an indicator. Further, the indicator field may indicate whether the activated TCI states can be associated with the non-serving cell information. Here, the length of the indicator field can be 1 bit, and it is set to 0 or 1. The indicator field set to one value of 0 or 1 can indicate that the activated TCI states can be configured in the serving cell, the indicator field set to another value indicates that the activated TCI states can be associated with the non-serving cell information. Here, the indicator field may be present only when the activated TCI states can be associated with the non-serving cell information. The indicator field in the MAC CE can be specific to the configured indicator of the reference signal in RRC IE TCI-State. For example, the indicator field in the MAC CE can be the same as or equal to the configured indicator.

Further, the indicator field may indicate that the activated TCI state(s) identified by the configured indicator of the reference signal in RRC IE TCI-State. The reference signal can be SSB or CSI-RS. The configured indicator indicates that the TCI-State can be associated with an additional PCI of a non-serving cell information or a serving cell PCI. The number of the configured non-serving cell information can be 1. The indicator field in the MAC CE can be the same as or equal to the configured indicator of the reference signal in RRC IE TCI-State. The indicator field in the MAC CE may be present only when the activated TCI states can be associated with a non-serving cell information.

In some embodiments, the UE receives a MAC CE to determine the activation or deactivation status of the TCI state(s) for a downlink reception. The downlink reception can be PDSCH. The MAC CE can be identified by a MAC subheader with LCID or eLCID. The MAC CE may include a field of the Serving Cell ID. Here, the Serving Cell ID indicates the identity of the Serving Cell for which the MAC CE applies.

Where the UE receives a MAC CE to determine the activation or deactivation status of the TCI state(s) for a downlink reception, the MAC CE may include a field of the BWP ID. Here, the BWP ID field indicates a DL BWP for which the MAC CE applies as the codepoint of the DCI bandwidth part indicator field. The length of the BWP ID field can be 2 bits. This field can be ignored if this MAC CE applies to a set of Serving Cells.

Where the UE receives a MAC CE to determine the activation or deactivation status of the TCI state(s) for a downlink reception, the MAC CE may include one or multiple fields that indicate the activation or deactivation status of the TCI state which configured by the RRC parameter TCI-StateId i. Further, the one or multiple fields can be a bitmap and each field can be denoted as “Tᵢ”. Here, the length of each Tᵢ field can be 1 bit and its value is set to 0 or 1. The Tᵢ field can be set to 1 to indicate that the TCI state with TCI-StateId i shall be activated and mapped to the codepoint of the DCI Transmission Configuration Indication field, the Tᵢ field is set to 0 to indicate that the TCI state with TCI-StateId i shall be deactivated and can be not mapped to the codepoint of the DCI Transmission Configuration Indication field. The codepoint of the DCI Transmission Configuration Indication field to which the TCI State can be mapped can be determined by its ordinal position among all the TCI States with Tᵢ field set to 1, i.e. the first TCI State with Tᵢ field set to 1 shall be mapped to the codepoint value 0, second TCI State with Tᵢ field set to 1 shall be mapped to the codepoint value 1 and so on. The maximum number of activated TCI states can be 8. The number of the fields can be variable and may depend on the RRC parameters tci-StatesToAddModList and tci-StatesToReleaseList in PDSCH-Config plus the configured indicator of the reference signal in RRC IE TCI-State.

Further, the one or multiple fields can be one or multiple codepoints, and each field can be denoted as “TCI State ID”. Here, the length of each TCI State ID field can be 7 bits, and its value can be any integer from 0 to 127. The value i of the TCI State ID field indicates that the TCI state with TCI-StateId i shall be activated and mapped to the codepoint of the DCI Transmission Configuration Indication field. The codepoint of the DCI Transmission Configuration Indication field to which the TCI State can be mapped can be determined by its ordinal position among all the TCI States activated by the TCI State ID field, i.e. the first TCI State with the lowest TCI State ID shall be mapped to the codepoint value 0, second TCI State with the second lowest TCI State ID shall be mapped to the codepoint value 1 and so on. The maximum number of activated TCI states can be 8. Here, the number of the fields can be variable and may depend on the RRC parameters tci-StatesToAddModList and tci-StatesToReleaseList in PDSCH-Config plus the configured indicator of the reference signal in RRC IE TCI-State.

Where the UE receives a MAC CE to determine the activation or deactivation status of the TCI state(s) for a downlink reception, the MAC CE may include a field of the CORESET Pool ID. Here, the CORESET Pool ID field indicates the mapping between the activated TCI states and the codepoint of the DCI Transmission Configuration Indication set by the Tᵢ or TCI State ID field can be specific to the associated ControlResourceSetId configured with CORESET Pool ID.

Where the UE receives a MAC CE to determine the activation or deactivation status of the TCI state(s) for a downlink reception, the MAC CE may include a field of an index.

Further, the index field can indicate the non-serving cell information that the activated TCI states can be associated with. The non-serving cell can be the cell with different PCI from the serving cell. The non-serving cell information can be configured by RRC and can be specified to the SSB in RRC IE TCI-State, which at least includes one of: an index, an additional PCI different from the serving cell PCI, SSB time domain position, SSB transmission periodicity, or SSB transmission power. The configured index indicates a non-serving cell information with an additional PCI. The maximum number of the non-serving cell information can be configured by RRC and depends on a reported UE capability. Here, if the UE reports the capability parameter of the maximum number, it means the UE can support inter-cell MTRP operation. If the UE does not report the capability parameter of the maximum number, it means the UE cannot support inter-cell MTRP operation. Only one non-serving cell information can be configured by RRC. If the non-serving cell information is not configured with the index, the index field in the MAC CE can be not present. If the non-serving cell information is configured with the index, the index field in the MAC CE can be specific to the configured index in the non-serving cell information. For example, the value of the the index field in the MAC CE can be the same as the configured index in the non-serving cell information. The number of the configured TCI states associated with the non-serving cell information can be dedicated to the additional PCI and can depend on the reported UE capability.

Where the UE receives a MAC CE to determine the activation or deactivation status of the TCI state(s) for a downlink reception, the MAC CE may include a field of an indicator. The indicator field may indicate that the activated TCI state(s) identified by the configured indicator of the reference signal in RRC IE TCI-State. The reference signal can be SSB or CSI-RS. Here, the configured indicator indicates that the TCI-State can be associated with an additional PCI of a non-serving cell information or a serving cell PCI. Here, the number of the configured non-serving cell information can be more than 1. The indicator field in the MAC CE can be the same as or equal to the configured indicator of the reference signal in RRC IE TCI-State. The indicator field in the MAC CE may be present only when the activated TCI states can be associated with a non-serving cell information.

In some embodiments, the UE receives a MAC CE to determine the activation or deactivation status of the TCI state(s) for a downlink reception. The downlink reception can be PDSCH. The MAC CE can be identified by a MAC subheader with LCID or eLCID. The MAC CE may include a field of the Serving Cell ID. Here, the Serving Cell ID indicates the identity of the Serving Cell for which the MAC CE applies.

Where the UE receives a MAC CE to determine the activation or deactivation status of the TCI state(s) for a downlink reception, the MAC CE may include a field of the BWP ID. Here, the BWP ID field indicates a DL BWP for which the MAC CE applies as the codepoint of the DCI bandwidth part indicator field. The length of the BWP ID field can be 2 bits. This field can be ignored if this MAC CE applies to a set of Serving Cells.

Where the UE receives a MAC CE to determine the activation or deactivation status of the TCI state(s) for a downlink reception, the MAC CE may include one or multiple fields that indicate the activation or deactivation status of the TCI state which configured by the RRC parameter TCI-StateId i. Here, the one or multiple fields can be a bitmap and each field can be denoted as “Tᵢ”. Here, the length of each Tᵢ field can be 1 bit and its value is set to 0 or 1. The Tᵢ field can be set to 1 to indicate that the TCI state with TCI-StateId i shall be activated and mapped to the codepoint of the DCI Transmission Configuration Indication field, the Tᵢ field is set to 0 to indicate that the TCI state with TCI-StateId i shall be deactivated and can be not mapped to the codepoint of the DCI Transmission Configuration Indication field. The codepoint of the DCI Transmission Configuration Indication field to which the TCI State can be mapped can be determined by its ordinal position among all the TCI States with Tᵢ field set to 1, i.e. the first TCI State with Tᵢ field set to 1 shall be mapped to the codepoint value 0, second TCI State with Tᵢ field set to 1 shall be mapped to the codepoint value 1 and so on. The maximum number of activated TCI states can be 8. Here, the number of the fields can be variable and may depend on the RRC parameters tci-StatesToAddModList and tci-StatesToReleaseList in PDSCH-Config plus the configured indicator of the reference signal in RRC IE TCI-State.

Further, the one or multiple fields can be one or multiple codepoints, and each field can be denoted as “TCI State ID”. Here, the length of each TCI State ID field can be 7 bits, and its value can be any integer from 0 to 127. The value i of the TCI State ID field indicates that the TCI state with TCI-StateId i shall be activated and mapped to the codepoint of the DCI Transmission Configuration Indication field. The codepoint of the DCI Transmission Configuration Indication field to which the TCI State can be mapped can be determined by its ordinal position among all the TCI States activated by the TCI State ID field, i.e. the first TCI State with the lowest TCI State ID shall be mapped to the codepoint value 0, second TCI State with the second lowest TCI State ID shall be mapped to the codepoint value 1 and so on. The maximum number of activated TCI states can be 8. Here, the number of the fields can be variable and may depend on the RRC parameters tci-StatesToAddModList and tci-StatesToReleaseList in PDSCH-Config plus the configured indicator of the reference signal in RRC IE TCI-State.

Where the UE receives a MAC CE to determine the activation or deactivation status of the TCI state(s) for a downlink reception, the MAC CE may include a field of the CORESET Pool ID. Here, the CORESET Pool ID field indicates the mapping between the activated TCI states and the codepoint of the DCI Transmission Configuration Indication set by the Tᵢ or TCI State ID field can be specific to the associated ControlResourceSetId configured with CORESET Pool ID. This field set to 1 indicates that this MAC CE shall be applied for the downlink reception scheduled by CORESET with the CORESET pool ID equal to 1, otherwise, this MAC CE shall be applied for the downlink reception scheduled by CORESET pool ID equal to 0.

Where the UE receives a MAC CE to determine the activation or deactivation status of the TCI state(s) for a downlink reception, the MAC CE may include a field of an index. Here, the index field indicates the non-serving cell information that the activated TCI states can be associated with. The non-serving cell can be the cell with different PCI from the serving cell. Further, the non-serving cell information can be determined by RRC configuration and can be specified to the SSB in RRC IE TCI-State, which at least includes one of: an index, an additional PCI different from the serving cell PCI, SSB time domain position, SSB transmission periodicity, or SSB transmission power. Here, the maximum number of the additional PCI of a non-serving cell information can be configured by RRC and depends on a reported UE capability. Here, if the UE reports the capability parameter of the maximum number, it means the UE can support inter-cell MTRP operation. If the UE does not report the capability parameter of the maximum number, it means the UE cannot support inter-cell MTRP operation.

More than one additional PCI of a non-serving cell information can be configured by RRC. Here, if the non-serving cell information is not configured with the index, the value of the index field in the MAC CE can be determined by the order of the additional PCI of the multiple non-serving cell information. For example, the value 0 of the index field in the MAC CE corresponds to the lowest additional PCI of the non-serving cell information, the value 1 of the index field in the MAC CE corresponds to the second lowest additional PCI of the non-serving cell information, and so on. For example, the value 0 of the index field in the MAC CE indicates the serving cell PCI, the value 1 of the index field in the MAC CE indicates the lowest additional PCI of the non-serving cell information, the value 2 of the index field in the MAC CE indicates the second lowest additional PCI of the non-serving cell information, and so on.

Further, if the non-serving cell information configured with the index, the index field in the MAC CE can be specific to the configured index in the non-serving cell information. For example, the value of the index field in the MAC CE can be the same as the configured index in the non-serving cell information. For example, the value of the index field in the MAC CE can be equal to the value of the configured index in the non-serving cell information plus 1. Here, the number of the configured TCI states associated with the non-serving cell information can be dedicated to one additional PCI and depends on the reported UE capability.

Where the UE receives a MAC CE to determine the activation or deactivation status of the TCI state(s) for a downlink reception, the MAC CE may include a field of an indicator. Here, the indicator field may indicate that the activated TCI state(s) identified by the configured indicator of the reference signal in RRC IE TCI-State. Here, the reference signal can be SSB or CSI-RS. Further, the configured indicator indicates that the TCI-State can be associated with an additional PCI of a non-serving cell information or a serving cell PCI. The number of the configured non-serving cell information can be more than 1. Here, the indicator field in the MAC CE can be the same as or equal to the configured indicator of the reference signal in RRC IE TCI-State. The indicator field in the MAC CE may be present only when the activated TCI states can be associated with a non-serving cell information.

FIG. 9 illustrates a fifth state indication, in accordance with present implementations. As illustrated by way of example in FIG. 9, an example state indication 900 can include an identifier octet 910, a configuration octet 920, and a TCI state identifier octet 930.

In some embodiments, the UE receives a MAC CE to determine the TCI state indication for a downlink reception. The downlink reception can be PDCCH. The MAC CE can be identified by a MAC subheader with LCID or eLCID. The MAC CE may include a field of the Serving Cell ID. Here, the Serving Cell ID indicates the identity of the Serving Cell for which the MAC CE applies.

Where the UE receives a MAC CE to determine the TCI state indication for a downlink reception, the MAC CE may include a field of the BWP ID. Here, the BWP ID field indicates a DL BWP for which the MAC CE applies as the codepoint of the DCI bandwidth part indicator field. The length of the BWP ID field can be 2 bits. This field can be ignored if this MAC CE applies to a set of Serving Cells.

Where the UE receives a MAC CE to determine the TCI state indication for a downlink reception, the MAC CE may include a field of a CORESET ID. Here, the CORESET ID field indicates a Control Resource Set identified with the RRC parameter ControlResourceSetId for which the TCI State can be being indicated. In case the value of the field can be 0, the field refers to the Control Resource Set configured by the RRC parameter controlResourceSetZero. The length of the field can be 4 bits. Further, the MAC CE may include a field of TCI state ID. Here, the TCI state ID indicates a TCI state identified by the RRC parameter TCI-StateId and applicable to the Control Resource Set identified by CORESET ID field. The length of the field can be 7 bits. If the field of CORESET ID is set to 0, this field indicates a RRC parameter TCI-StateId for a TCI state of the first 64 TCI-states configured by the RRC parameters tci-States-ToAddModList and tci-States-ToReleaseList in the PDSCH-Config in the active BWP. If the field of CORESET ID can be set to the other value than 0, this field indicates a RRC parameter TCI-StateId configured by the RRC parameters tci-StatesPDCCH-ToAddList and tci-StatesPDCCH-ToReleaseList in the controlResourceSet identified by the indicated CORESET ID.

Where the UE receives a MAC CE to determine the TCI state indication for a downlink reception, the MAC CE may include a field of an index. Further, the index field can indicate the non-serving cell information that the indicated TCI state can be associated with. Here, the non-serving cell can be the cell with different PCI from the serving cell. Further the non-serving cell information can be configured by RRC and can be specified to the SSB in RRC IE TCI-State, which at least includes one of: an index, an additional PCI different from the serving cell PCI, SSB time domain position, SSB transmission periodicity, or SSB transmission power. Here, the configured index indicates a non-serving cell information with an additional PCI. The maximum number of the non-serving cell information can be configured by RRC and depends on a reported UE capability. Here, if the UE reports the capability parameter of the maximum number, it means the UE can support inter-cell MTRP operation. If the UE does not report the capability parameter of the maximum number, it means the UE cannot support inter-cell MTRP operation. Here, only one non-serving cell information can be configured by RRC. If the non-serving cell information is not configured with the index, the index field in the MAC CE can be not present. If the non-serving cell information configured with the index, the index field in the MAC CE can be specific to the configured index in the non-serving cell information. For example, the value of the index field in the MAC CE can be the same as the configured index in the non-serving cell information. Here, the number of the configured TCI states associated with the non-serving cell information can be dedicated to the additional PCI and depends on the reported UE capability.

Where the UE receives a MAC CE to determine the TCI state indication for a downlink reception, the MAC CE may include a field of an indicator. Here, the indicator field may indicate whether the indicated TCI state can be associated with the non-serving cell information. Here, the length of the indicator field can be 1 bit, and it is set to 0 or 1. Here, the indicator field set to one value of 0 or 1 indicates that the indicated TCI state can be configured in the serving cell, the indicator field set to another value indicates that the indicated TCI state can be associated with the non-serving cell information. Here, the indicator field may be present only when the indicated TCI state can be associated with the non-serving cell information. Here, the indicator field in the MAC CE can be specific to the configured indicator of the reference signal in RRC IE TCI-State. For example, the indicator field in the MAC CE can be the same as or equal to the configured indicator.

Further, the indicator field may indicate that the indicated TCI state identified by the configured indicator of the reference signal in RRC IE TCI-State. Here, the reference signal can be SSB or CSI-RS. The configured indicator can indicate that the TCI-State can be associated with an additional PCI of a non-serving cell information or a serving cell PCI. Here, the number of the configured non-serving cell information can be 1. Here, the indicator field in the MAC CE can be the same as or equal to the configured indicator of the reference signal in RRC IE TCI-State. The indicator field in the MAC CE may be present only when the activated TCI states can be associated with a non-serving cell information.

In some embodiments, the UE receives a MAC CE to determine the TCI state indication for a downlink reception. The downlink reception can be PDCCH. The MAC CE can be identified by a MAC subheader with LCID or eLCID.

Where the UE receives a MAC CE to determine the TCI state indication for a downlink reception, the MAC CE may include a field of the Serving Cell ID. Here, the Serving Cell ID indicates the identity of the Serving Cell for which the MAC CE applies.

Where the UE receives a MAC CE to determine the TCI state indication for a downlink reception, the MAC CE may include a field of the BWP ID. Here, the BWP ID field indicates a DL BWP for which the MAC CE applies as the codepoint of the DCI bandwidth part indicator field. The length of the BWP ID field can be 2 bits. This field can be ignored if this MAC CE applies to a set of Serving Cells. Here, the MAC CE may include a field of a CORESET ID. Here, the CORESET ID field indicates a Control Resource Set identified with the RRC parameter ControlResourceSetId for which the TCI State can be being indicated. In case the value of the field can be 0, the field refers to the Control Resource Set configured by the RRC parameter controlResourceSetZero. The length of the field can be 4 bits.

Where the UE receives a MAC CE to determine the TCI state indication for a downlink reception, the MAC CE may include a field of TCI state ID. Here, the TCI state ID indicates a TCI state identified by the RRC parameter TCI-StateId and applicable to the Control Resource Set identified by CORESET ID field. The length of the field can be 7 bits. Here, if the field of CORESET ID is set to 0, this field indicates a RRC parameter TCI-StateId for a TCI state of the first 64 TCI-states configured by the RRC parameters tci-States-ToAddModList and tci-States-ToReleaseList in the PDSCH-Config in the active BWP. If the field of CORESET ID can be set to the other value than 0, this field indicates a RRC parameter TCI-StateId configured by the RRC parameters tci-StatesPDCCH-ToAddList and tci-StatesPDCCH-ToReleaseList in the controlResourceSet identified by the indicated CORESET ID.

Where the UE receives a MAC CE to determine the TCI state indication for a downlink reception, the MAC CE may include a field of an index. Further, the index field indicates the non-serving cell information that the indicated TCI state can be associated with. Here, the non-serving cell can be the cell with different PCI from the serving cell. Here, the non-serving cell information can be determined by RRC configuration and can be specified to the SSB in RRC IE TCI-State, which at least includes one of: an index, an additional PCI different from the serving cell PCI, SSB time domain position, SSB transmission periodicity, or SSB transmission power. The maximum number of the additional PCI of a non-serving cell information can be configured by RRC and depends on a reported UE capability. Here, if the UE reports the capability parameter of the maximum number, it means the UE can support inter-cell MTRP operation. If the UE does not report the capability parameter of the maximum number, it means the UE cannot support inter-cell MTRP operation. More than one additional PCI of a non-serving cell information can be configured by RRC.

Further, if the non-serving cell information is not configured with the index, the value of the index field in the MAC CE can be determined by the order of the additional PCI of the multiple non-serving cell information. For example, the value 0 of the index field in the MAC CE corresponds to the lowest additional PCI of the non-serving cell information, the value 1 of the index field in the MAC CE corresponds to the second lowest additional PCI of the non-serving cell information, and so on. For example, the value 0 of the index field in the MAC CE indicates the serving cell PCI, the value 1 of the index field in the MAC CE indicates the lowest additional PCI of the non-serving cell information, the value 2 of the index field in the MAC CE indicates the second lowest additional PCI of the non-serving cell information, and so on. Here, if the non-serving cell information configured with the index, the index field in the MAC CE can be specific to the configured index in the non-serving cell information. For example, the value of the index field in the MAC CE can be the same as the configured index in the non-serving cell information. For example, the value of the index field in the MAC CE can be equal to the value of the configured index in the non-serving cell information plus 1. Here, the number of the configured TCI states associated with the non-serving cell information can be dedicated to one additional PCI and depends on the reported UE capability.

Where the UE receives a MAC CE to determine the TCI state indication for a downlink reception, the MAC CE may include a field of an indicator. Here, the indicator field may indicate whether the indicated TCI state can be associated with the non-serving cell information. Here, the length of the indicator field can be 1 bit, and it is set to 0 or 1. Here, the indicator field set to one value of 0 or 1 indicates that the indicated TCI state can be configured in the serving cell, the indicator field set to another value indicates that the indicated TCI state can be associated with the non-serving cell information. Here, the indicator field may be present only when the activated TCI states can be associated with the non-serving cell information. The indicator field in the MAC CE can be specific to the configured indicator of the reference signal in RRC IE TCI-State. For example, the indicator field in the MAC CE can be the same as or equal to the configured indicator. Here, the indicator field may indicate that the indicated TCI state identified by the configured indicator of the reference signal in RRC IE TCI-State. The reference signal can be SSB or CSI-RS. Further, the configured indicator can indicate that the TCI-State can be associated with an additional PCI of a non-serving cell information or a serving cell PCI. Here, the number of the configured non-serving cell information can be 1. Here, the indicator field in the MAC CE can be the same as or equal to the configured indicator of the reference signal in RRC IE TCI-State. Here, the indicator field in the MAC CE may be present only when the indicated TCI state can be associated with a non-serving cell information.

In some embodiments, the UE receives a MAC CE to determine the TCI state indication for a downlink reception. The downlink reception can be PDCCH. The MAC CE can be identified by a MAC subheader with LCID or eLCID. The MAC CE may include a field of the Serving Cell ID. The Serving Cell ID can indicate the identity of the Serving Cell for which the MAC CE applies. Further, the MAC CE may include a field of the BWP ID. Here, the BWP ID field indicates a DL BWP for which the MAC CE applies as the codepoint of the DCI bandwidth part indicator field. The length of the BWP ID field can be 2 bits. This field can be ignored if this MAC CE applies to a set of Serving Cells. Further, the MAC CE may include a field of a CORESET ID. Here, the CORESET ID field indicates a Control Resource Set identified with the RRC parameter ControlResourceSetId for which the TCI State can be being indicated. In case the value of the field can be 0, the field refers to the Control Resource Set configured by the RRC parameter controlResourceSetZero. The length of the field can be 4 bits.

Where the UE receives a MAC CE to determine the TCI state indication for a downlink reception, the MAC CE may include a field of TCI state ID. Here, the TCI state ID indicates a TCI state identified by the RRC parameter TCI-StateId and applicable to the Control Resource Set identified by CORESET ID field. The length of the field can be 7 bits. If the field of CORESET ID is set to 0, this field can indicate a RRC parameter TCI-StateId for a TCI state of the first 64 TCI-states configured by the RRC parameters tci-States-ToAddModList and tci-States-ToReleaseList in the PDSCH-Config in the active BWP. If the field of CORESET ID can be set to the other value than 0, this field indicates a RRC parameter TCI-StateId configured by the RRC parameters tci-StatesPDCCH-ToAddList and tci-StatesPDCCH-ToReleaseList in the controlResourceSet identified by the indicated CORESET ID.

Where the UE receives a MAC CE to determine the TCI state indication for a downlink reception, the MAC CE may include a field of an index. Here, the index field indicates the non-serving cell information that the indicated TCI state can be associated with. The non-serving cell can be the cell with different PCI from the serving cell. The non-serving cell information can be configured by RRC and can be specified to the SSB in RRC IE TCI-State, which at least includes one of: an index, an additional PCI different from the serving cell PCI, SSB time domain position, SSB transmission periodicity, or SSB transmission power. Here, the configured index indicates a non-serving cell information with an additional PCI. Here, the maximum number of the non-serving cell information can be configured by RRC and depends on a reported UE capability. Here, if the UE reports the capability parameter of the maximum number, it means the UE can support inter-cell MTRP operation. If the UE does not report the capability parameter of the maximum number, it means the UE cannot support inter-cell MTRP operation. Here, only one non-serving cell information can be configured by RRC. Here, if the non-serving cell information is not configured with the index, the index field in the MAC CE can be not present. If the non-serving cell information is configured with the index, the index field in the MAC CE can be specific to the configured index in the non-serving cell information. For example, the value of the the index field in the MAC CE can be the same as the configured index in the non-serving cell information. Here, the number of the configured TCI states associated with the non-serving cell information can be dedicated to the additional PCI and depends on the reported UE capability.

Where the UE receives a MAC CE to determine the TCI state indication for a downlink reception, the MAC CE may include a field of an indicator. Here, the indicator field may indicate that the indicated TCI state identified by the configured indicator of the reference signal in RRC IE TCI-State. The reference signal can be SSB or CSI-RS. Here, the configured indicator indicates that the TCI-State can be associated with an additional PCI of a non-serving cell information or a serving cell PCI. The number of the configured non-serving cell information can be more than 1. Here, the indicator field in the MAC CE can be the same as or equal to the configured indicator of the reference signal in RRC IE TCI-State. Here, the indicator field in the MAC CE may be present only when the activated TCI states can be associated with a non-serving cell information.

In some embodiments, the UE receives a MAC CE to determine the TCI state indication for a downlink reception. The downlink reception can be PDCCH. The MAC CE can be identified by a MAC subheader with LCID or eLCID. The MAC CE may include a field of the Serving Cell ID. Here, the Serving Cell ID indicates the identity of the Serving Cell for which the MAC CE applies.

Where the UE receives a MAC CE to determine the TCI state indication for a downlink reception, the MAC CE may include a field of the BWP ID. Here, the BWP ID field indicates a DL BWP for which the MAC CE applies as the codepoint of the DCI bandwidth part indicator field. The length of the BWP ID field can be 2 bits. This field can be ignored if this MAC CE applies to a set of Serving Cells.

Where the UE receives a MAC CE to determine the TCI state indication for a downlink reception, the MAC CE may include a field of a CORESET ID. Here, the CORESET ID field indicates a Control Resource Set identified with the RRC parameter ControlResourceSetId for which the TCI State can be being indicated. In case the value of the field can be 0, the field refers to the Control Resource Set configured by the RRC parameter controlResourceSetZero. The length of the field can be 4 bits.

Where the UE receives a MAC CE to determine the TCI state indication for a downlink reception, the MAC CE may include a field of TCI state ID. Here, the TCI state ID indicates a TCI state identified by the RRC parameter TCI-StateId and applicable to the Control Resource Set identified by CORESET ID field. The length of the field can be 7 bits. If the field of CORESET ID is set to 0, this field indicates a RRC parameter TCI-StateId for a TCI state of the first 64 TCI-states configured by the RRC parameters tci-States-ToAddModList and tci-States-ToReleaseList in the PDSCH-Config in the active BWP. If the field of CORESET ID can be set to the other value than 0, this field indicates a RRC parameter TCI-StateId configured by the RRC parameters tci-StatesPDCCH-ToAddList and tci-StatesPDCCH-ToReleaseList in the controlResourceSet identified by the indicated CORESET ID.

Where the UE receives a MAC CE to determine the TCI state indication for a downlink reception, the MAC CE may include a field of an index. Further, the index field can indicate the non-serving cell information that the indicated TCI state can be associated with. Here, the non-serving cell can be the cell with different PCI from the serving cell. The non-serving cell information can be determined by RRC configuration and can be specified to the SSB in RRC IE TCI-State, which at least includes one of: an index, an additional PCI different from the serving cell PCI, SSB time domain position, SSB transmission periodicity, or SSB transmission power. Further, the maximum number of the additional PCI of a non-serving cell information can be configured by RRC and depends on a reported UE capability. Here, if the UE reports the capability parameter of the maximum number, it means the UE can support inter-cell MTRP operation. If the UE does not report the capability parameter of the maximum number, it means the UE cannot support inter-cell MTRP operation. Here, more than one additional PCI of a non-serving cell information can be configured by RRC.

Further, if the non-serving cell information is not configured with the index, the value of the index field in the MAC CE can be determined by the order of the additional PCI of the multiple non-serving cell information. For example, the value 0 of the index field in the MAC CE corresponds to the lowest additional PCI of the non-serving cell information, the value 1 of the index field in the MAC CE corresponds to the second lowest additional PCI of the non-serving cell information, and so on. For example, the value 0 of the index field in the MAC CE indicates the serving cell PCI, the value 1 of the index field in the MAC CE indicates the lowest additional PCI of the non-serving cell information, the value 2 of the index field in the MAC CE indicates the second lowest additional PCI of the non-serving cell information, and so on. Here, if the non-serving cell information configured with the index, the index field in the MAC CE can be specific to the configured index in the non-serving cell information. For example, the value of the index field in the MAC CE can be the same as the configured index in the non-serving cell information. For example, the value of the index field in the MAC CE can be equal to the value of the configured index in the non-serving cell information plus 1. Here, the number of the configured TCI states associated with the non-serving cell information can be dedicated to one additional PCI and depends on the reported UE capability.

Where the UE receives a MAC CE to determine the TCI state indication for a downlink reception, the MAC CE may include a field of an indicator. Here, the indicator field may indicate that the indicated TCI state identified by the configured indicator of the reference signal in RRC IE TCI-State. The reference signal can be SSB or CSI-RS. Here, the configured indicator indicates that the TCI-State can be associated with an additional PCI of a non-serving cell information or a serving cell PCI. The number of the configured non-serving cell information can be more than 1. The indicator field in the MAC CE can be the same as or equal to the configured indicator of the reference signal in RRC IE TCI-State. The indicator field in the MAC CE may be present only when the activated TCI states can be associated with a non-serving cell information.

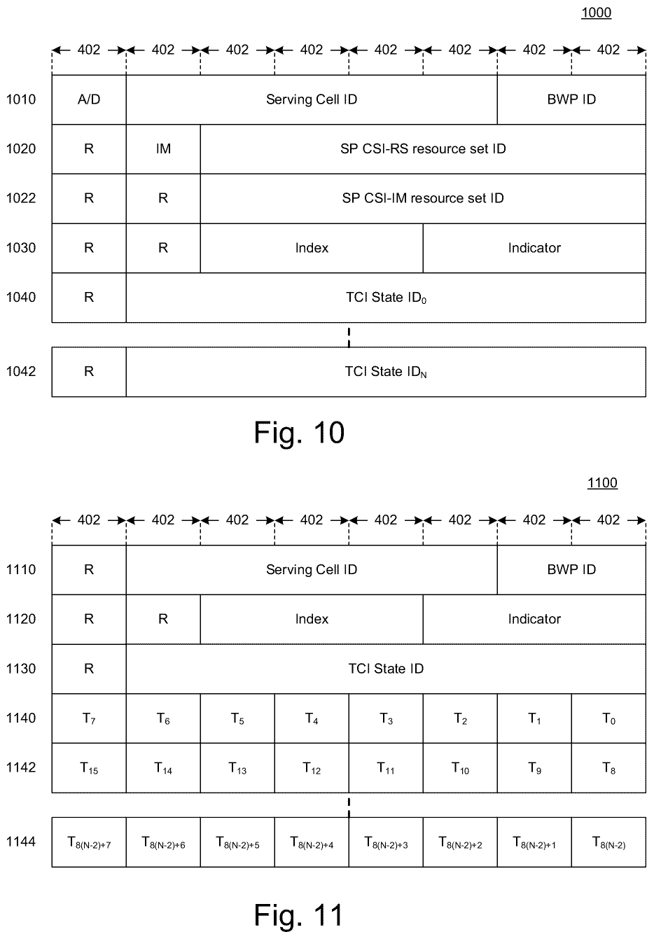

FIG. 10 illustrates a sixth state indication, in accordance with present implementations. As illustrated by way of example in FIG. 10, an example state indication 1000 can include TTT. state indication 1000 can include an identifier octet 1010, a first configuration octet 1020, a second configuration octet 1022, a third configuration octet 1024, a first TCI state identifier octet 1030, and a second TCI state identifier octet 1032. It is to be understood that the number of TCI state identifier octets can be greater than or less than the number illustrated by way of example herein.

In some embodiments, the UE receives a MAC CE to determine the activation or deactivation status of the TCI state(s) for a downlink reception. Here, the downlink reception can be SP (semi-persistent) CSI-RS/CSI-IM (Interference Measurement). Here, the MAC CE can be identified by a MAC subheader with LCID or eLCID.

Where the UE receives a MAC CE to determine the activation or deactivation status of the TCI state(s) for a downlink reception, the MAC CE may include a field of the Serving Cell ID. Here, the Serving Cell ID indicates the identity of the Serving Cell for which the MAC CE applies.

Where the UE receives a MAC CE to determine the activation or deactivation status of the TCI state(s) for a downlink reception, the MAC CE may include a field indicates whether to activate or deactivate indicated SP CSI-RS and CSI-IM resource set(s). Here, the field can be set to 1 to indicate activation, otherwise the field can indicate deactivation.

Where the UE receives a MAC CE to determine the activation or deactivation status of the TCI state(s) for a downlink reception, the MAC CE may include a field of the BWP ID. Here, the BWP ID field indicates a DL BWP for which the MAC CE applies as the codepoint of the DCI bandwidth part indicator field. The length of the BWP ID field can be 2 bits.

Where the UE receives a MAC CE to determine the activation or deactivation status of the TCI state(s) for a downlink reception, the MAC CE may include a field of a SP CSI-RS resource set ID. Here, this field contains an index of NZP-CSI-RS-ResourceSet containing Semi Persistent NZP CSI-RS resources to indicate the Semi Persistent NZP CSI-RS resource set, which shall be activated or deactivated. The length of the field can be 6 bits.

Where the UE receives a MAC CE to determine the activation or deactivation status of the TCI state(s) for a downlink reception, the MAC CE may include a field of IM. Here, the IM field field indicates the presence of the octet containing SP CSI-IM resource set ID field. If this field can be set to 1, the octet containing SP CSI-IM resource set ID field can be present. If this field is set to 0, the octet containing SP CSI-IM resource set ID field can be not present.

Where the UE receives a MAC CE to determine the activation or deactivation status of the TCI state(s) for a downlink reception, the MAC CE may include a field of a SP CSI-IM resource set ID. Here, this field contains an index of CSI-IM-ResourceSet containing Semi Persistent CSI-IM resources to indicate the Semi Persistent CSI-IM resource set, which shall be activated or deactivated. The length of the field can be 6 bits.

Where the UE receives a MAC CE to determine the activation or deactivation status of the TCI state(s) for a downlink reception, the MAC CE may include one or multiple fields that indicate the activation or deactivation status of the TCI state which configured by the RRC parameter TCI-StateId i, and which can be used as QCL source for the resource within the Semi Persistent NZP CSI-RS resource set indicated by SP CSI-RS resource set ID field. If the A/D field is set to 0, the field(s) can be not present. Further, the one or multiple fields can be a bitmap and each field can be denoted as “Tᵢ”. Here, the length of each Tᵢ field can be 1 bit and its value is set to 0 or 1. The Tᵢ field can be set to 1 to indicate that the TCI state with TCI-StateId i shall be activated and mapped to the codepoint of the DCI Transmission Configuration Indication field, the Tᵢ field is set to 0 to indicate that the TCI state with TCI-StateId i shall be deactivated and can be not mapped to the codepoint of the DCI Transmission Configuration Indication field. The codepoint of the DCI Transmission Configuration Indication field to which the TCI State can be mapped can be determined by its ordinal position among all the TCI States with Tᵢ field set to 1, i.e. the first TCI State with Tᵢ field set to 1 shall be mapped to the codepoint value 0, second TCI State with Tᵢ field set to 1 shall be mapped to the codepoint value 1 and so on. Further the one or multiple fields can be one or multiple codepoints, and each field can be denoted as “TCI State ID”.

The value i of the TCI State ID field indicates that the TCI state with TCI-StateId i shall be activated and mapped to the codepoint of the DCI Transmission Configuration Indication field. The codepoint of the DCI Transmission Configuration Indication field to which the TCI State can be mapped can be determined by its ordinal position among all the TCI States activated by the TCI State ID field, i.e. the first TCI State with the lowest TCI State ID shall be mapped to the codepoint value 0, second TCI State with the second lowest TCI State ID shall be mapped to the codepoint value 1 and so on.

Where the UE receives a MAC CE to determine the activation or deactivation status of the TCI state(s) for a downlink reception, the MAC CE may include a field of an index. Here, the index field indicates the non-serving cell information that the activated TCI states can be associated with. The non-serving cell can be the cell with different PCI from the serving cell. The non-serving cell information can be configured by RRC and can be specified to the SSB in RRC IE TCI-State, which at least includes one of: an index, an additional PCI different from the serving cell PCI, SSB time domain position, SSB transmission periodicity, or SSB transmission power. Here, the configured index indicates a non-serving cell information with an additional PCI. Further, the maximum number of the non-serving cell information can be configured by RRC and depends on a reported UE capability. Here, if the UE reports the capability parameter of the maximum number, it means the UE can support inter-cell MTRP operation. If the UE does not report the capability parameter of the maximum number, it means the UE cannot support inter-cell MTRP operation. Here, only one non-serving cell information can be configured by RRC. If the non-serving cell information is not configured with the index, the index field in the MAC CE can be not present. If the non-serving cell information configured with the index, the index field in the MAC CE can be specific to the configured index in the non-serving cell information. For example, the value of the the index field in the MAC CE can be the same as the configured index in the non-serving cell information. Here, the number of the configured TCI states associated with the non-serving cell information can be dedicated to the additional PCI and depends on the reported UE capability.

Where the UE receives a MAC CE to determine the activation or deactivation status of the TCI state(s) for a downlink reception, the MAC CE may include a field of an indicator. Here, the indicator field may indicate whether the activated TCI states can be associated with the non-serving cell information. Here, the length of the indicator field can be 1 bit, and it is set to 0 or 1. Here, the indicator field set to one value of 0 or 1 indicates that the activated TCI states can be configured in the serving cell, the indicator field set to another value indicates that the activated TCI states can be associated with the non-serving cell information. Here, the indicator field may be present only when the activated TCI states can be associated with the non-serving cell information. The indicator field in the MAC CE can be specific to the configured indicator of the reference signal in RRC IE TCI-State. For example, the indicator field in the MAC CE can be the same as or equal to the configured indicator. Here, the indicator field may indicate that the activated TCI state(s) identified by the configured indicator of the reference signal in RRC IE TCI-State. The reference signal can be SSB or CSI-RS. Further, the configured indicator indicates that the TCI-State can be associated with an additional PCI of a non-serving cell information or a serving cell PCI. Here, the number of the configured non-serving cell information can be 1. The indicator field in the MAC CE can be the same as or equal to the configured indicator of the reference signal in RRC IE TCI-State. The indicator field in the MAC CE may be present only when the activated TCI states can be associated with a non-serving cell information.

In some embodiments, the UE receives a MAC CE to determine the activation or deactivation status of the TCI state(s) for a downlink reception. Here, the downlink reception can be SP (semi-persistent) CSI-RS/CSI-IM (Interference Measurement). Here, the MAC CE can be identified by a MAC subheader with LCID or eLCID. Here, the MAC CE may include a field of the Serving Cell ID. The Serving Cell ID indicates the identity of the Serving Cell for which the MAC CE applies. Here, the MAC CE may include a field indicates whether to activate or deactivate indicated SP CSI-RS and CSI-IM resource set(s). Here, the field can be set to 1 to indicate activation, otherwise it indicates deactivation;

Where the UE receives a MAC CE to determine the activation or deactivation status of the TCI state(s) for a downlink reception, the MAC CE may include a field of the BWP ID. Here, the BWP ID field indicates a DL BWP for which the MAC CE applies as the codepoint of the DCI bandwidth part indicator field. The length of the BWP ID field can be 2 bits.

Where the UE receives a MAC CE to determine the activation or deactivation status of the TCI state(s) for a downlink reception, the MAC CE may include a field of a SP CSI-RS resource set ID. Here, this field contains an index of NZP-CSI-RS-ResourceSet containing Semi Persistent NZP CSI-RS resources to indicate the Semi Persistent NZP CSI-RS resource set, which shall be activated or deactivated. The length of the field can be 6 bits. Further, the MAC CE may include a field of IM. The IM field can indicate the presence of the octet containing SP CSI-IM resource set ID field. If this field can be set to 1, the octet containing SP CSI-IM resource set ID field can be present. If this field is set to 0, the octet containing SP CSI-IM resource set ID field can be not present.

Where the UE receives a MAC CE to determine the activation or deactivation status of the TCI state(s) for a downlink reception, the MAC CE may include a field of a SP CSI-IM resource set ID. Here, this field contains an index of CSI-IM-ResourceSet containing Semi Persistent CSI-IM resources to indicate the Semi Persistent CSI-IM resource set, which shall be activated or deactivated. The length of the field can be 6 bits.

Where the UE receives a MAC CE to determine the activation or deactivation status of the TCI state(s) for a downlink reception, the MAC CE may include one or multiple fields that indicate the activation or deactivation status of the TCI state which configured by the RRC parameter TCI-StateId i, and which can be used as QCL source for the resource within the Semi Persistent NZP CSI-RS resource set indicated by SP CSI-RS resource set ID field. If the A/D field is set to 0, the field(s) can be not present. Further, the one or multiple fields can be a bitmap and each field can be denoted as “Tᵢ”. Here, the length of each Tᵢ field can be 1 bit and its value is set to 0 or 1. The Tᵢ field can be set to 1 to indicate that the TCI state with TCI-StateId i shall be activated and mapped to the codepoint of the DCI Transmission Configuration Indication field, the Tᵢ field is set to 0 to indicate that the TCI state with TCI-StateId i shall be deactivated and can be not mapped to the codepoint of the DCI Transmission Configuration Indication field. The codepoint of the DCI Transmission Configuration Indication field to which the TCI State can be mapped can be determined by its ordinal position among all the TCI States with Tᵢ field set to 1, i.e. the first TCI State with Tᵢ field set to 1 shall be mapped to the codepoint value 0, second TCI State with Tᵢ field set to 1 shall be mapped to the codepoint value 1 and so on. Further, the one or multiple fields can be one or multiple codepoints, and each field can be denoted as “TCI State ID”. The value i of the TCI State ID field can indicate that the TCI state with TCI-StateId i shall be activated and mapped to the codepoint of the DCI Transmission Configuration Indication field. The codepoint of the DCI Transmission Configuration Indication field to which the TCI State can be mapped can be determined by its ordinal position among all the TCI States activated by the TCI State ID field, i.e. the first TCI State with the lowest TCI State ID shall be mapped to the codepoint value 0, second TCI State with the second lowest TCI State ID shall be mapped to the codepoint value 1 and so on.

Where the UE receives a MAC CE to determine the activation or deactivation status of the TCI state(s) for a downlink reception, the MAC CE may include a field of an index. Here, the index field indicates the non-serving cell information that the activated TCI states can be associated with. Here, the non-serving cell can be the cell with different PCI from the serving cell. The non-serving cell information can be determined by RRC configuration and can be specified to the SSB in RRC IE TCI-State, which at least includes one of: an index, an additional PCI different from the serving cell PCI, SSB time domain position, SSB transmission periodicity, or SSB transmission power. The maximum number of the additional PCI of a non-serving cell information can be configured by RRC and depends on a reported UE capability. Here, if the UE reports the capability parameter of the maximum number, it means the UE can support inter-cell MTRP operation. If the UE does not report the capability parameter of the maximum number, it means the UE cannot support inter-cell MTRP operation. Here, more than one additional PCI of a non-serving cell information can be configured by RRC. If the non-serving cell information is not configured with the index, the value of the index field in the MAC CE can be determined by the order of the additional PCI of the multiple non-serving cell information. For example, the value 0 of the index field in the MAC CE corresponds to the lowest additional PCI of the non-serving cell information, the value 1 of the index field in the MAC CE corresponds to the second lowest additional PCI of the non-serving cell information, and so on. For example, the value 0 of the index field in the MAC CE indicates the serving cell PCI, the value 1 of the index field in the MAC CE indicates the lowest additional PCI of the non-serving cell information, the value 2 of the index field in the MAC CE indicates the second lowest additional PCI of the non-serving cell information, and so on.

Further, if the non-serving cell information configured with the index, the index field in the MAC CE can be specific to the configured index in the non-serving cell information. For example, the value of the index field in the MAC CE can be the same as the configured index in the non-serving cell information. For example, the value of the index field in the MAC CE can be equal to the value of the configured index in the non-serving cell information plus 1. Here, the number of the configured TCI states associated with the non-serving cell information can be dedicated to one additional PCI and depends on the reported UE capability.

Where the UE receives a MAC CE to determine the activation or deactivation status of the TCI state(s) for a downlink reception, the MAC CE may include a field of an indicator. Here, the indicator field may indicate whether the activated TCI states can be associated with the non-serving cell information. Here, the length of the indicator field can be 1 bit, and it is set to 0 or 1. Here, the indicator field set to one value of 0 or 1 indicates that the activated TCI states can be configured in the serving cell, the indicator field set to another value indicates that the activated TCI states can be associated with the non-serving cell information. The indicator field may be present only when the activated TCI states can be associated with the non-serving cell information. The indicator field in the MAC CE can be specific to the configured indicator of the reference signal in RRC IE TCI-State. For example, the indicator field in the MAC CE can be the same as or equal to the configured indicator.

Further, the indicator field may indicate that the activated TCI state(s) identified by the configured indicator of the reference signal in RRC IE TCI-State. The reference signal can be SSB or CSI-RS. Here, the configured indicator indicates that the TCI-State can be associated with an additional PCI of a non-serving cell information or a serving cell PCI. The number of the configured non-serving cell information can be 1. Here, the indicator field in the MAC CE can be the same as or equal to the configured indicator of the reference signal in RRC IE TCI-State. Here, the indicator field in the MAC CE may be present only when the activated TCI states can be associated with a non-serving cell information.

In some embodiments, the UE receives a MAC CE to determine the activation or deactivation status of the TCI state(s) for a downlink reception.

Where the UE receives a MAC CE to determine the activation or deactivation status of the TCI state(s) for a downlink reception, the downlink reception can be SP (semi-persistent) CSI-RS/CSI-IM (Interference Measurement). Here, the MAC CE can be identified by a MAC subheader with LCID or eLCID. The MAC CE may include a field of the Serving Cell ID. Here, the Serving Cell ID indicates the identity of the Serving Cell for which the MAC CE applies.

Where the UE receives a MAC CE to determine the activation or deactivation status of the TCI state(s) for a downlink reception, the MAC CE may include a field indicates whether to activate or deactivate indicated SP CSI-RS and CSI-IM resource set(s). Here, the field can be set to 1 to indicate activation, otherwise it indicates deactivation. Where the UE receives a MAC CE to determine the activation or deactivation status of the TCI state(s) for a downlink reception, the MAC CE may include a field of the BWP ID. Here, the BWP ID field indicates a DL BWP for which the MAC CE applies as the codepoint of the DCI bandwidth part indicator field. The length of the BWP ID field can be 2 bits.

Where the UE receives a MAC CE to determine the activation or deactivation status of the TCI state(s) for a downlink reception, the MAC CE may include a field of a SP CSI-RS resource set ID. Here, this field contains an index of NZP-CSI-RS-ResourceSet containing Semi Persistent NZP CSI-RS resources to indicate the Semi Persistent NZP CSI-RS resource set, which shall be activated or deactivated. The length of the field can be 6 bits.

Where the UE receives a MAC CE to determine the activation or deactivation status of the TCI state(s) for a downlink reception, the MAC CE may include a field of IM. Here, the IM field field indicates the presence of the octet containing SP CSI-IM resource set ID field. If this field can be set to 1, the octet containing SP CSI-IM resource set ID field can be present. If this field is set to 0, the octet containing SP CSI-IM resource set ID field can be not present.

Where the UE receives a MAC CE to determine the activation or deactivation status of the TCI state(s) for a downlink reception, the MAC CE may include a field of a SP CSI-IM resource set ID. Here, this field contains an index of CSI-IM-ResourceSet containing Semi Persistent CSI-IM resources to indicate the Semi Persistent CSI-IM resource set, which shall be activated or deactivated. The length of the field can be 6 bits.

Where the UE receives a MAC CE to determine the activation or deactivation status of the TCI state(s) for a downlink reception, the MAC CE may include one or multiple fields that indicate the activation or deactivation status of the TCI state which configured by the RRC parameter TCI-StateId i, and which can be used as QCL source for the resource within the Semi Persistent NZP CSI-RS resource set indicated by SP CSI-RS resource set ID field. If the A/D field is set to 0, the field(s) can be not present. Here, the one or multiple fields can be a bitmap and each field can be denoted as “Tᵢ”. Here, the length of each Tᵢ field can be 1 bit and its value is set to 0 or 1. The Tᵢ field can be set to 1 to indicate that the TCI state with TCI-StateId i shall be activated and mapped to the codepoint of the DCI Transmission Configuration Indication field, the Tᵢ field is set to 0 to indicate that the TCI state with TCI-StateId i shall be deactivated and can be not mapped to the codepoint of the DCI Transmission Configuration Indication field. The codepoint of the DCI Transmission Configuration Indication field to which the TCI State can be mapped can be determined by its ordinal position among all the TCI States with Tᵢ field set to 1, i.e. the first TCI State with Tᵢ field set to 1 shall be mapped to the codepoint value 0, second TCI State with Tᵢ field set to 1 shall be mapped to the codepoint value 1 and so on. Here, the one or multiple fields can be one or multiple codepoints, and each field can be denoted as “TCI State ID”. The value i of the TCI State ID field can indicate that the TCI state with TCI-StateId i shall be activated and mapped to the codepoint of the DCI Transmission Configuration Indication field. The codepoint of the DCI Transmission Configuration Indication field to which the TCI State can be mapped can be determined by its ordinal position among all the TCI States activated by the TCI State ID field, i.e. the first TCI State with the lowest TCI State ID shall be mapped to the codepoint value 0, second TCI State with the second lowest TCI State ID shall be mapped to the codepoint value 1 and so on.

Where the UE receives a MAC CE to determine the activation or deactivation status of the TCI state(s) for a downlink reception, the MAC CE may include a field of an index. Here, the index field indicates the non-serving cell information that the activated TCI states can be associated with. Here, the non-serving cell can be the cell with different PCI from the serving cell. Here, the non-serving cell information can be configured by RRC and can be specified to the SSB in RRC IE TCI-State, which at least includes one of: an index, an additional PCI different from the serving cell PCI, SSB time domain position, SSB transmission periodicity, or SSB transmission power. Here, the configured index indicates a non-serving cell information with an additional PCI. Further, the maximum number of the non-serving cell information can be configured by RRC and depends on a reported UE capability. Here, if the UE reports the capability parameter of the maximum number, it means the UE can support inter-cell MTRP operation. If the UE does not report the capability parameter of the maximum number, it means the UE cannot support inter-cell MTRP operation. Here, only one non-serving cell information can be configured by RRC. If the non-serving cell information is not configured with the index, the index field in the MAC CE can be not present. If the non-serving cell information configured with the index, the index field in the MAC CE can be specific to the configured index in the non-serving cell information. For example, the value of the index field in the MAC CE can be the same as the configured index in the non-serving cell information. Here, the number of the configured TCI states associated with the non-serving cell information can be dedicated to the additional PCI and depends on the reported UE capability. Where the UE receives a MAC CE to determine the activation or deactivation status of the TCI state(s) for a downlink reception, the MAC CE may include a field of an indicator. Here, the indicator field may indicate that the activated TCI state(s) identified by the configured indicator of the reference signal in RRC IE TCI-State. The signal can be SSB or CSI-RS. The configured indicator indicates that the TCI-State can be associated with an additional PCI of a non-serving cell information or a serving cell PCI. The number of the configured non-serving cell information can be more than 1. The indicator field in the MAC CE can be the same as or equal to the configured indicator of the reference signal in RRC IE TCI-State. Here, the indicator field in the MAC CE may be present only when the activated TCI states can be associated with a non-serving cell information.

In some embodiments, the UE receives a MAC CE to determine the activation or deactivation status of the TCI state(s) for a downlink reception. Where the UE receives a MAC CE to determine the activation or deactivation status of the TCI state(s) for a downlink reception, the downlink reception can be SP (semi-persistent) CSI-RS/CSI-IM (Interference Measurement). Where the UE receives a MAC CE to determine the activation or deactivation status of the TCI state(s) for a downlink reception, the MAC CE can be identified by a MAC subheader with LCID or eLCID. Where the UE receives a MAC CE to determine the activation or deactivation status of the TCI state(s) for a downlink reception, the MAC CE may include a field of the Serving Cell ID. Here, the Serving Cell ID indicates the identity of the Serving Cell for which the MAC CE applies.

Where the UE receives a MAC CE to determine the activation or deactivation status of the TCI state(s) for a downlink reception, the MAC CE may include a field indicates whether to activate or deactivate indicated SP CSI-RS and CSI-IM resource set(s). Here, the field can be set to 1 to indicate activation, otherwise it indicates deactivation. Where the UE receives a MAC CE to determine the activation or deactivation status of the TCI state(s) for a downlink reception, the MAC CE may include a field of the BWP ID. Here, the BWP ID field indicates a DL BWP for which the MAC CE applies as the codepoint of the DCI bandwidth part indicator field. The length of the BWP ID field can be 2 bits.

Where the UE receives a MAC CE to determine the activation or deactivation status of the TCI state(s) for a downlink reception, the MAC CE may include a field of a SP CSI-RS resource set ID. Here, this field contains an index of NZP-CSI-RS-ResourceSet containing Semi Persistent NZP CSI-RS resources to indicate the Semi Persistent NZP CSI-RS resource set, which shall be activated or deactivated. The length of the field can be 6 bits.

Where the UE receives a MAC CE to determine the activation or deactivation status of the TCI state(s) for a downlink reception, the MAC CE may include a field of IM. Here, the IM field indicates the presence of the octet containing SP CSI-IM resource set ID field. If this field can be set to 1, the octet containing SP CSI-IM resource set ID field can be present. If this field is set to 0, the octet containing SP CSI-IM resource set ID field can be not present.

Where the UE receives a MAC CE to determine the activation or deactivation status of the TCI state(s) for a downlink reception, the MAC CE may include a field of a SP CSI-IM resource set ID. Here, this field contains an index of CSI-IM-ResourceSet containing Semi Persistent CSI-IM resources to indicate the Semi Persistent CSI-IM resource set, which shall be activated or deactivated. The length of the field can be 6 bits.

Where the UE receives a MAC CE to determine the activation or deactivation status of the TCI state(s) for a downlink reception, the MAC CE may include one or multiple fields that indicate the activation or deactivation status of the TCI state which configured by the RRC parameter TCI-StateId i, and which can be used as QCL source for the resource within the Semi Persistent NZP CSI-RS resource set indicated by SP CSI-RS resource set ID field. If the A/D field is set to 0, the field(s) can be not present.

Here, the one or multiple fields can be a bitmap and each field can be denoted as “Tᵢ”. Here, the length of each Tᵢ field can be 1 bit and its value is set to 0 or 1. The Tᵢ field can be set to 1 to indicate that the TCI state with TCI-StateId i shall be activated and mapped to the codepoint of the DCI Transmission Configuration Indication field, the Tᵢ field is set to 0 to indicate that the TCI state with TCI-StateId i shall be deactivated and can be not mapped to the codepoint of the DCI Transmission Configuration Indication field. The codepoint of the DCI Transmission Configuration Indication field to which the TCI State can be mapped can be determined by its ordinal position among all the TCI States with Tᵢ field set to 1, i.e. the first TCI State with Tᵢ field set to 1 shall be mapped to the codepoint value 0, second TCI State with Tᵢ field set to 1 shall be mapped to the codepoint value 1 and so on. Here, the one or multiple fields can be one or multiple codepoints, and each field can be denoted as “TCI State ID”. The value i of the TCI State ID field can indicate that the TCI state with TCI-StateId i shall be activated and mapped to the codepoint of the DCI Transmission Configuration Indication field. The codepoint of the DCI Transmission Configuration Indication field to which the TCI State can be mapped can be determined by its ordinal position among all the TCI States activated by the TCI State ID field, i.e. the first TCI State with the lowest TCI State ID shall be mapped to the codepoint value 0, second TCI State with the second lowest TCI State ID shall be mapped to the codepoint value 1 and so on.

Where the UE receives a MAC CE to determine the activation or deactivation status of the TCI state(s) for a downlink reception, the MAC CE may include a field of an index. Here, the index field indicates the non-serving cell information that the activated TCI states can be associated with. The non-serving cell can be the cell with different PCI from the serving cell. The non-serving cell information can be determined by RRC configuration and can be specified to the SSB in RRC IE TCI-State, which at least includes one of: an index, an additional PCI different from the serving cell PCI, SSB time domain position, SSB transmission periodicity, or SSB transmission power. Further, maximum number of the additional PCI of a non-serving cell information can be configured by RRC and depends on a reported UE capability. Here, if the UE reports the capability parameter of the maximum number, it means the UE can support inter-cell MTRP operation. If the UE does not report the capability parameter of the maximum number, it means the UE cannot support inter-cell MTRP operation. More than one additional PCI of a non-serving cell information can be configured by RRC.

Here, if the non-serving cell information is not configured with the index, the value of the index field in the MAC CE can be determined by the order of the additional PCI of the multiple non-serving cell information. For example, the value 0 of the index field in the MAC CE corresponds to the lowest additional PCI of the non-serving cell information, the value 1 of the index field in the MAC CE corresponds to the second lowest additional PCI of the non-serving cell information, and so on. For example, the value 0 of the index field in the MAC CE indicates the serving cell PCI, the value 1 of the index field in the MAC CE indicates the lowest additional PCI of the non-serving cell information, the value 2 of the index field in the MAC CE indicates the second lowest additional PCI of the non-serving cell information, and so on.

Further, if the non-serving cell information configured with the index, the index field in the MAC CE can be specific to the configured index in the non-serving cell information. For example, the value of the index field in the MAC CE can be the same as the configured index in the non-serving cell information. For example, the value of the index field in the MAC CE can be equal to the value of the configured index in the non-serving cell information plus 1. Here, the number of the configured TCI states associated with the non-serving cell information can be dedicated to one additional PCI and depends on the reported UE capability.

Where the UE receives a MAC CE to determine the activation or deactivation status of the TCI state(s) for a downlink reception, the MAC CE may include a field of an indicator. Here, the indicator field may indicate that the activated TCI state(s) identified by the configured indicator of the reference signal in RRC IE TCI-State. The reference signal can be SSB or CSI-RS. The configured indicator indicates that the TCI-State can be associated with an additional PCI of a non-serving cell information or a serving cell PCI. Here, the number of the configured non-serving cell information can be more than 1. The indicator field in the MAC CE can be the same as or equal to the configured indicator of the reference signal in RRC IE TCI-State. The indicator field in the MAC CE may be present only when the activated TCI states can be associated with a non-serving cell information.

FIG. 11 illustrates a seventh state indication, in accordance with present implementations. As illustrated by way of example in FIG. 11, an example state indication 1100 can include an identifier octet 1110, a configuration octet 1120, a first TCI state octet 1130, a second TCI state octet 1132, and a third TCI state octet 1134. It is to be understood that the number of TCI state octets can be greater than or less than the number illustrated by way of example herein.

In some embodiments, the UE receives a MAC CE to determine the aperiodic CSI Trigger State subselection for a downlink reception. The downlink reception can be aperiodic CSI-RS. The MAC CE can be identified by a MAC subheader with LCID or eLCID. The MAC CE may include a field of the Serving Cell ID. The Serving Cell ID indicates the identity of the Serving Cell for which the MAC CE applies.

Where the UE receives a MAC CE to determine the aperiodic CSI Trigger State subselection for a downlink reception, the MAC CE may include a field of the BWP ID. Here, the BWP ID field indicates a DL BWP for which the MAC CE applies as the codepoint of the DCI bandwidth part indicator field. The length of the BWP ID field can be 2 bits.

Where the UE receives a MAC CE to determine the aperiodic CSI Trigger State subselection for a downlink reception, the MAC CE may include one or multiple fields that indicate the selection status of the Aperiodic Trigger States configured within the RRC parameter aperiodicTriggerStateList. Here, the one or multiple fields can be a bitmap and each field can be denoted as “Tᵢ”. The length of each Tᵢ field can be 1 bit and its value is set to 0 or 1. The Tᵢ field can be set to 1 to indicate that the Aperiodic Trigger State i shall be mapped to the codepoint of the DCI CSI request field, the Tᵢ field is set to 0 to indicate that the Aperiodic Trigger State i shall not be mapped to the codepoint of the DCI CSI request field. The codepoint of the DCI CSI request field to which the Aperiodic Trigger State can be mapped can be determined by its ordinal position among all the Aperiodic Trigger States with Tᵢ field set to 1, i.e. the first Aperiodic Trigger State with Tᵢ field set to 1 shall be mapped to the codepoint value 0, second Aperiodic Trigger State with Tᵢ field set to 1 shall be mapped to the codepoint value 1 and so on.

Further, the one or multiple fields can be one or multiple codepoints, and each field can be denoted as “Aperiodic Trigger State ID”. The value i of the Aperiodic Trigger State ID field can indicate that the Aperiodic Trigger State with CSI-ReportConfigId i shall be selected and mapped to the codepoint of the DCI CSI request field. The codepoint of the DCI CSI request field to which the Aperiodic Trigger State can be mapped can be determined by its ordinal position among all the Aperiodic Trigger States selected by the Aperiodic Trigger State ID field, i.e. the first Aperiodic Trigger State with the lowest Aperiodic Trigger State ID shall be mapped to the codepoint value 0, second Aperiodic Trigger State with the second lowest Aperiodic Trigger State ID shall be mapped to the codepoint value 1 and so on.

Where the UE receives a MAC CE to determine the aperiodic CSI Trigger State subselection for a downlink reception, the MAC CE may include a field of an index. Here, the index field indicates the non-serving cell information that the TCI states of the selected Aperiodic Trigger States can be associated with. Here, the non-serving cell can be the cell with different PCI from the serving cell. Here, the non-serving cell information can be configured by RRC and can be specified to the SSB in RRC IE TCI-State, which at least includes one of: an index, an additional PCI different from the serving cell PCI, SSB time domain position, SSB transmission periodicity, or SSB transmission power. Here, the configured index indicates a non-serving cell information with an additional PCI. The maximum number of the non-serving cell information can be configured by RRC and depends on a reported UE capability. Here, if the UE reports the capability parameter of the maximum number, it means the UE can support inter-cell MTRP operation. If the UE does not report the capability parameter of the maximum number, it means the UE cannot support inter-cell MTRP operation.

Further, only one non-serving cell information can be configured by RRC. Here, if the non-serving cell information is not configured with the index, the index field in the MAC CE can be not present. If the non-serving cell information is configured with the index, the index field in the MAC CE can be specific to the configured index in the non-serving cell information. For example, the value of the index field in the MAC CE can be the same as the configured index in the non-serving cell information. Here, the number of the configured TCI states associated with the non-serving cell information can be dedicated to the additional PCI and depends on the reported UE capability.

Where the UE receives a MAC CE to determine the aperiodic CSI Trigger State subselection for a downlink reception, the MAC CE may include a field of an indicator. Further, the indicator field may indicate whether the TCI states of the selected Aperiodic Trigger States can be associated with the non-serving cell information. The length of the indicator field can be 1 bit, and it is set to 0 or 1. Here, the indicator field set to one value of 0 or 1 indicates that the activated TCI states can be configured in the serving cell, the indicator field set to another value indicates that the activated TCI states can be associated with the non-serving cell information. The indicator field may be present only when the TCI states of the selected Aperiodic Trigger States can be associated with the non-serving cell information. The indicator field in the MAC CE can be specific to the configured indicator of the reference signal in RRC IE TCI-State. For example, the indicator field in the MAC CE can be the same as or equal to the configured indicator. Here, the indicator field may indicate that the TCI state(s) of the selected Aperiodic Trigger States can be identified by the configured indicator of the reference signal in RRC IE TCI-State. The e reference signal can be SSB or CSI-RS. The configured indicator indicates that the TCI-State can be associated with an additional PCI of a non-serving cell information or a serving cell PCI. The number of the configured non-serving cell information can be 1. The indicator field in the MAC CE can be the same as or equal to the configured indicator of the reference signal in RRC IE TCI-State. Here, the indicator field in the MAC CE may be present only when the TCI states of the selected Aperiodic Trigger States can be associated with a non-serving cell information.

In some embodiments, the UE receives a MAC CE to determine the aperiodic CSI Trigger State subselection for a downlink reception. The downlink reception can be aperiodic CSI-RS. The MAC CE can be identified by a MAC subheader with LCID or eLCID. The MAC CE may include a field of the Serving Cell ID. Here, the Serving Cell ID indicates the identity of the Serving Cell for which the MAC CE applies.

Where the UE receives a MAC CE to determine the aperiodic CSI Trigger State subselection for a downlink reception, the MAC CE may include a field of the BWP ID. Here, the BWP ID field indicates a DL BWP for which the MAC CE applies as the codepoint of the DCI bandwidth part indicator field. The length of the BWP ID field can be 2 bits.

Where the UE receives a MAC CE to determine the aperiodic CSI Trigger State subselection for a downlink reception, the MAC CE may include one or multiple fields that indicate the selection status of the Aperiodic Trigger States configured within the RRC parameter aperiodicTriggerStateList. Further, the one or multiple fields can be a bitmap and each field can be denoted as “Tᵢ”. Here, the length of each Tᵢ field can be 1 bit and its value is set to 0 or 1. The Tᵢ field can be set to 1 to indicate that the Aperiodic Trigger State i shall be mapped to the codepoint of the DCI CSI request field, the Tᵢ field is set to 0 to indicate that the Aperiodic Trigger State i shall not be mapped to the codepoint of the DCI CSI request field. The codepoint of the DCI CSI request field to which the Aperiodic Trigger State can be mapped can be determined by its ordinal position among all the Aperiodic Trigger States with Tᵢ field set to 1, i.e. the first Aperiodic Trigger State with Tᵢ field set to 1 shall be mapped to the codepoint value 0, second Aperiodic Trigger State with Tᵢ field set to 1 shall be mapped to the codepoint value 1 and so on.

Further, the one or multiple fields can be one or multiple codepoints, and each field can be denoted as “Aperiodic Trigger State ID”. The value i of the Aperiodic Trigger State ID field indicates that the Aperiodic Trigger State with CSI-ReportConfigId i shall be selected and mapped to the codepoint of the DCI CSI request field. The codepoint of the DCI CSI request field to which the Aperiodic Trigger State can be mapped can be determined by its ordinal position among all the Aperiodic Trigger States selected by the Aperiodic Trigger State ID field, i.e. the first Aperiodic Trigger State with the lowest Aperiodic Trigger State ID shall be mapped to the codepoint value 0, second Aperiodic Trigger State with the second lowest Aperiodic Trigger State ID shall be mapped to the codepoint value 1 and so on.

Where the UE receives a MAC CE to determine the aperiodic CSI Trigger State subselection for a downlink reception, the MAC CE may include a field of an index. Here, the index field indicates the non-serving cell information that the TCI states of the selected Aperiodic Trigger States can be associated with. The non-serving cell can be the cell with different PCI from the serving cell. The non-serving cell information can be determined by RRC configuration and can be specified to the SSB in RRC IE TCI-State, which at least includes one of: an index, an additional PCI different from the serving cell PCI, SSB time domain position, SSB transmission periodicity, or SSB transmission power. Further, the maximum number of the additional PCI of a non-serving cell information can be configured by RRC and depends on a reported UE capability. Here, if the UE reports the capability parameter of the maximum number, it means the UE can support inter-cell MTRP operation. If the UE does not report the capability parameter of the maximum number, it means the UE cannot support inter-cell MTRP operation. More than one additional PCI of a non-serving cell information can be configured by RRC.

Further, if the non-serving cell information is not configured with the index, the value of the index field in the MAC CE can be determined by the order of the additional PCI of the multiple non-serving cell information. For example, the value 0 of the index field in the MAC CE corresponds to the lowest additional PCI of the non-serving cell information, the value 1 of the index field in the MAC CE corresponds to the second lowest additional PCI of the non-serving cell information, and so on. For example, the value 0 of the index field in the MAC CE indicates the serving cell PCI, the value 1 of the index field in the MAC CE indicates the lowest additional PCI of the non-serving cell information, the value 2 of the index field in the MAC CE indicates the second lowest additional PCI of the non-serving cell information, and so on.

Further, if the non-serving cell information configured with the index, the index field in the MAC CE can be specific to the configured index in the non-serving cell information. For example, the value of the index field in the MAC CE can be the same as the configured index in the non-serving cell information. For example, the value of the index field in the MAC CE can be equal to the value of the configured index in the non-serving cell information plus 1. Here, the number of the configured TCI states associated with the non-serving cell information can be dedicated to one additional PCI and depends on the reported UE capability.

Where the UE receives a MAC CE to determine the aperiodic CSI Trigger State subselection for a downlink reception, the MAC CE may include a field of an indicator. Further, the indicator field may indicate whether the TCI states of the selected Aperiodic Trigger States can be associated with the non-serving cell information. The length of the indicator field can be 1 bit, and it is set to 0 or 1. Here, the indicator field set to one value of 0 or 1 indicates that the TCI states of the selected Aperiodic Trigger States can be configured in the serving cell, the indicator field set to another value indicates that the TCI states the selected Aperiodic Trigger States can be associated with the non-serving cell information. The indicator field may be present only when the TCI states of the selected Aperiodic Trigger States can be associated with the non-serving cell information. The indicator field in the MAC CE can be specific to the configured indicator of the reference signal in RRC IE TCI-State. For example, the indicator field in the MAC CE can be the same as or equal to the configured indicator.

Further, the indicator field may indicate that the TCI state(s) of the selected Aperiodic Trigger States can be identified by the configured indicator of the reference signal in RRC IE TCI-State. The reference signal can be SSB or CSI-RS. Here, the configured indicator indicates that the TCI-State can be associated with an additional PCI of a non-serving cell information or a serving cell PCI. Here, the number of the configured non-serving cell information can be 1. The indicator field in the MAC CE can be the same as or equal to the configured indicator of the reference signal in RRC IE TCI-State. The indicator field in the MAC CE may be present only when the TCI states of the selected Aperiodic Trigger States can be associated with a non-serving cell information.

In some embodiments, the UE receives a MAC CE to determine the aperiodic CSI Trigger State subselection for a downlink reception. The downlink reception can be aperiodic CSI-RS. The MAC CE can be identified by a MAC subheader with LCID or eLCID. The MAC CE may include a field of the Serving Cell ID. Here, the Serving Cell ID indicates the identity of the Serving Cell for which the MAC CE applies.

Where the UE receives a MAC CE to determine the aperiodic CSI Trigger State subselection for a downlink reception, the MAC CE may include a field of the BWP ID. Here, the BWP ID field indicates a DL BWP for which the MAC CE applies as the codepoint of the DCI bandwidth part indicator field. The length of the BWP ID field can be 2 bits.

Where the UE receives a MAC CE to determine the aperiodic CSI Trigger State subselection for a downlink reception, the MAC CE may include one or multiple fields that indicate the selection status of the Aperiodic Trigger States configured within the RRC parameter aperiodicTriggerStateList. Further, the one or multiple fields can be a bitmap and each field can be denoted as “Tᵢ”. Here, the length of each Tᵢ field can be 1 bit and its value is set to 0 or 1. The Tᵢ field can be set to 1 to indicate that the Aperiodic Trigger State i shall be mapped to the codepoint of the DCI CSI request field, the Tᵢ field is set to 0 to indicate that the Aperiodic Trigger State i shall not be mapped to the codepoint of the DCI CSI request field. The codepoint of the DCI CSI request field to which the Aperiodic Trigger State can be mapped can be determined by its ordinal position among all the Aperiodic Trigger States with Tᵢ field set to 1, i.e. the first Aperiodic Trigger State with Tᵢ field set to 1 shall be mapped to the codepoint value 0, second Aperiodic Trigger State with Tᵢ field set to 1 shall be mapped to the codepoint value 1 and so on. The one or multiple fields can be one or multiple codepoints, and each field can be denoted as “Aperiodic Trigger State ID”. The value i of the Aperiodic Trigger State ID field can indicate that the Aperiodic Trigger State with CSI-ReportConfigId i shall be selected and mapped to the codepoint of the DCI CSI request field. The codepoint of the DCI CSI request field to which the Aperiodic Trigger State can be mapped can be determined by its ordinal position among all the Aperiodic Trigger States selected by the Aperiodic Trigger State ID field, i.e. the first Aperiodic Trigger State with the lowest Aperiodic Trigger State ID shall be mapped to the codepoint value 0, second Aperiodic Trigger State with the second lowest Aperiodic Trigger State ID shall be mapped to the codepoint value 1 and so on.

Where the UE receives a MAC CE to determine the aperiodic CSI Trigger State subselection for a downlink reception, the MAC CE may include a field of an index. Further, the index field indicates the non-serving cell information that the TCI states of the selected Aperiodic Trigger States can be associated with. The non-serving cell can be the cell with different PCI from the serving cell. The non-serving cell information can be configured by RRC and can be specified to the SSB in RRC IE TCI-State, which at least includes one of: an index, an additional PCI different from the serving cell PCI, SSB time domain position, SSB transmission periodicity, or SSB transmission power. Here, the configured index indicates a non-serving cell information with an additional PCI. The maximum number of the non-serving cell information can be configured by RRC and depends on a reported UE capability. Here, if the UE reports the capability parameter of the maximum number, it means the UE can support inter-cell MTRP operation. If the UE does not report the capability parameter of the maximum number, it means the UE cannot support inter-cell MTRP operation. Here, only one non-serving cell information can be configured by RRC. If the non-serving cell information is not configured with the index, the index field in the MAC CE can be not present. If the non-serving cell information configured with the index, the index field in the MAC CE can be specific to the configured index in the non-serving cell information. For example, the value of the the index field in the MAC CE can be the same as the configured index in the non-serving cell information. Here, the number of the configured TCI states associated with the non-serving cell information can be dedicated to the additional PCI and depends on the reported UE capability.

Where the UE receives a MAC CE to determine the aperiodic CSI Trigger State subselection for a downlink reception, the MAC CE may include a field of an indicator. Further, the indicator field may indicate that the TCI state(s) of the selected Aperiodic Trigger States can be identified by the configured indicator of the reference signal in RRC IE TCI-State. Here, the reference signal can be SSB or CSI-RS. Here, the configured indicator indicates that the TCI-State can be associated with an additional PCI of a non-serving cell information or a serving cell PCI. The number of the configured non-serving cell information can be more than 1. Here, the indicator field in the MAC CE can be the same as or equal to the configured indicator of the reference signal in RRC IE TCI-State. Here, the indicator field in the MAC CE may be present only when the TCI states of the selected Aperiodic Trigger States can be associated with a non-serving cell information.

In some embodiments, the UE receives a MAC CE to determine the aperiodic CSI Trigger State subselection for a downlink reception. The downlink reception can be aperiodic CSI-RS. The MAC CE can be identified by a MAC subheader with LCID or eLCID. The MAC CE may include a field of the Serving Cell ID. Here, the Serving Cell ID indicates the identity of the Serving Cell for which the MAC CE applies. The MAC CE may include a field of the BWP ID. Here, the BWP ID field indicates a DL BWP for which the MAC CE applies as the codepoint of the DCI bandwidth part indicator field. The length of the BWP ID field can be 2 bits.

Where the UE receives a MAC CE to determine the aperiodic CSI Trigger State subselection for a downlink reception, the MAC CE may include one or multiple fields that indicate the selection status of the Aperiodic Trigger States configured within the RRC parameter aperiodicTriggerStateList. Further, the one or multiple fields can be a bitmap and each field can be denoted as “Tᵢ”. Here, the length of each Tᵢ field can be 1 bit and its value is set to 0 or 1. The Tᵢ field can be set to 1 to indicate that the Aperiodic Trigger State i shall be mapped to the codepoint of the DCI CSI request field, the Tᵢ field is set to 0 to indicate that the Aperiodic Trigger State i shall not be mapped to the codepoint of the DCI CSI request field. The codepoint of the DCI CSI request field to which the Aperiodic Trigger State can be mapped can be determined by its ordinal position among all the Aperiodic Trigger States with Tᵢ field set to 1, i.e. the first Aperiodic Trigger State with Tᵢ field set to 1 shall be mapped to the codepoint value 0, second Aperiodic Trigger State with Tᵢ field set to 1 shall be mapped to the codepoint value 1 and so on.

Further, the one or multiple fields can be one or multiple codepoints, and each field can be denoted as “Aperiodic Trigger State ID”. The value i of the Aperiodic Trigger State ID field can indicate that the Aperiodic Trigger State with CSI-ReportConfigId i shall be selected and mapped to the codepoint of the DCI CSI request field. The codepoint of the DCI CSI request field to which the Aperiodic Trigger State can be mapped can be determined by its ordinal position among all the Aperiodic Trigger States selected by the Aperiodic Trigger State ID field, i.e. the first Aperiodic Trigger State with the lowest Aperiodic Trigger State ID shall be mapped to the codepoint value 0, second Aperiodic Trigger State with the second lowest Aperiodic Trigger State ID shall be mapped to the codepoint value 1 and so on.

Where the UE receives a MAC CE to determine the aperiodic CSI Trigger State subselection for a downlink reception, the MAC CE may include a field of an index. Here, the index field indicates the non-serving cell information that the TCI states of the selected Aperiodic Trigger States can be associated with. Further, the non-serving cell can be the cell with different PCI from the serving cell. Here, the non-serving cell information can be determined by RRC configuration and can be specified to the SSB in RRC IE TCI-State, which at least includes one of: an index, an additional PCI different from the serving cell PCI, SSB time domain position, SSB transmission periodicity, or SSB transmission power. The maximum number of the additional PCI of a non-serving cell information can be configured by RRC and depends on a reported UE capability. Here, if the UE reports the capability parameter of the maximum number, it means the UE can support inter-cell MTRP operation. If the UE does not report the capability parameter of the maximum number, it means the UE cannot support inter-cell MTRP operation. More than one additional PCI of a non-serving cell information can be configured by RRC. If the non-serving cell information is not configured with the index, the value of the index field in the MAC CE can be determined by the order of the additional PCI of the multiple non-serving cell information. For example, the value 0 of the index field in the MAC CE corresponds to the lowest additional PCI of the non-serving cell information, the value 1 of the index field in the MAC CE corresponds to the second lowest additional PCI of the non-serving cell information, and so on. For example, the value 0 of the index field in the MAC CE indicates the serving cell PCI, the value 1 of the index field in the MAC CE indicates the lowest additional PCI of the non-serving cell information, the value 2 of the index field in the MAC CE indicates the second lowest additional PCI of the non-serving cell information, and so on.

Further, if the non-serving cell information is configured with the index, the index field in the MAC CE can be specific to the configured index in the non-serving cell information. For example, the value of the index field in the MAC CE can be the same as the configured index in the non-serving cell information. For example, the value of the index field in the MAC CE can be equal to the value of the configured index in the non-serving cell information plus 1. Here, the number of the configured TCI states associated with the non-serving cell information can be dedicated to one additional PCI and depends on the reported UE capability.

Where the UE receives a MAC CE to determine the aperiodic CSI Trigger State subselection for a downlink reception, the MAC CE may include a field of an indicator. Here, the indicator field may indicate that the TCI state(s) of the selected Aperiodic Trigger States can be identified by the configured indicator of the reference signal in RRC IE TCI-State. The reference signal can be SSB or CSI-RS. The configured indicator indicates that the TCI-State can be associated with an additional PCI of a non-serving cell information or a serving cell PCI. The number of the configured non-serving cell information can be more than 1. The indicator field in the MAC CE can be the same as or equal to the configured indicator of the reference signal in RRC IE TCI-State. The indicator field in the MAC CE may be present only when the TCI states of the selected Aperiodic Trigger States can be associated with a non-serving cell information.

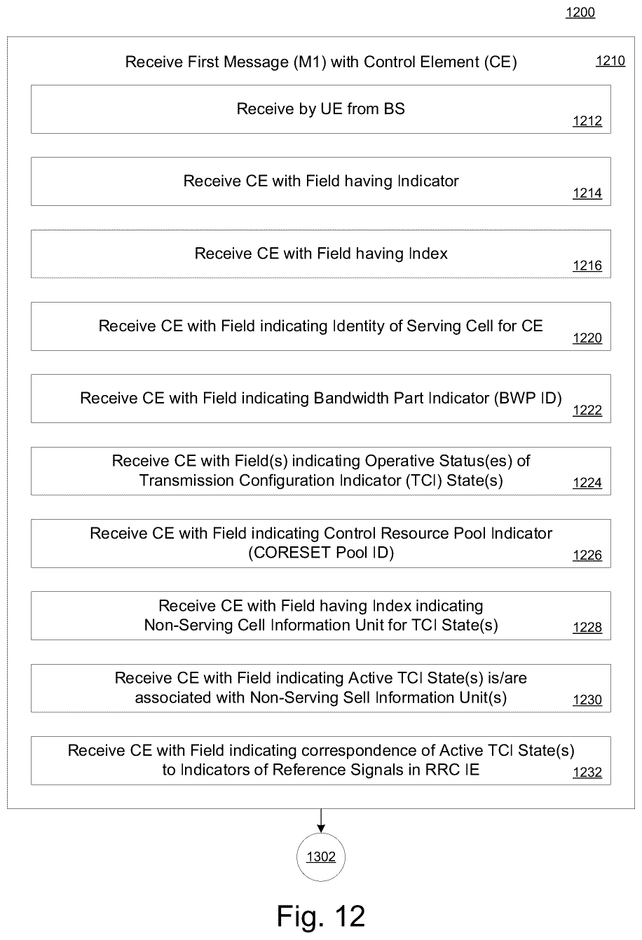

FIG. 12 illustrates a first method of indicating TCI states under multi-TRP operation, in accordance with present implementations. At least one of the systems 100 and 200 can perform method 1200 according to present implementations. The method 1200 can begin at step 1210.

At step 1210, the method can receive a first message including a control element. Step 1210 can include at least one of steps 1212, 1214, 1216, 1220, 1222, 1224, 1226, 1228, 1230 and 1232. At step 1212, the method can receive the first message by the UE from the BS. At step 1214, the method can receive the control element with a field having an indicator. At step 1216, the method can receive the control element with a field having an index. At step 1220, the method can receive the control element with a field indicating an identity of a serving cell associated with the control element. At step 1222, the method can receive the control element with a field indicating a bandwidth part indicator. At step 1224, the method can receive the control element with one or more fields indicating one or more operating statuses of one or more corresponding TCI states. At step 1226, the method can receive the control element with a field indicating a control resource pool indicator. At step 1228, the method can receive the control element with a field having an index indicating at least one non-serving cell information unit for at least one corresponding TCI state. At step 1230, the method can receive the control element with a field indicating whether one or more active TCI states can be associated with corresponding non-serving cell information units. At step 1232, the method can receive the control element with a field indicating correspondence of active TCI states to indicators of reference signals in RRC IE. The method 1200 can then continue to step 1302.

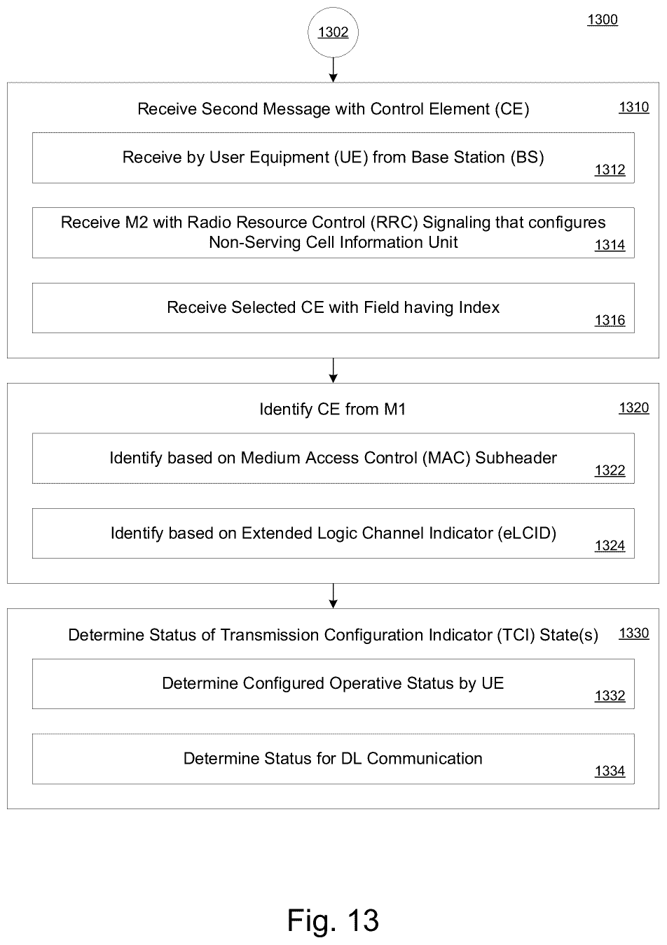

FIG. 13 illustrates a second method of indicating TCI states under multi-TRP operation, further to the method of FIG. 13. At least one of the systems 100 and 200 can perform method 1300 according to present implementations. The method 1300 can begin at step 1302. The method 1300 can then continue to step 1310.

At step 1310, the method can receive a second message with a control element. Step 1310 can include at least one of steps 1312, 1314 and 1316. At step 1312, the method can receive the second message by the UE from the BS. At step 1314, the method can receive the second message with a radio resource control signaling that configures at least one non-serving cell information unit. At step 1316, the method can receive the second message with a selected control element with a field having an index. The method 1300 can then continue to step 1320.

At step 1320, the method can identify the control element from the first message. Step 1320 can include at least one of steps 1322 and 1324. At step 1322, the method can identify the control element based on a medium access control subheader. At step 1324, the method can identify the control element based on at least one extended logic channel indicator. The method 1300 can then continue to step 1330.

At step 1330, the method can determine at least one status of at least one TCI states. Step 1330 can include at least one of steps 1332 and 1334. At step 1332, the method can determine at least one configured operative status by the UE. At step 1334, the method can determine at least one status for downlink communication. The method 1300 can end at step 1334.

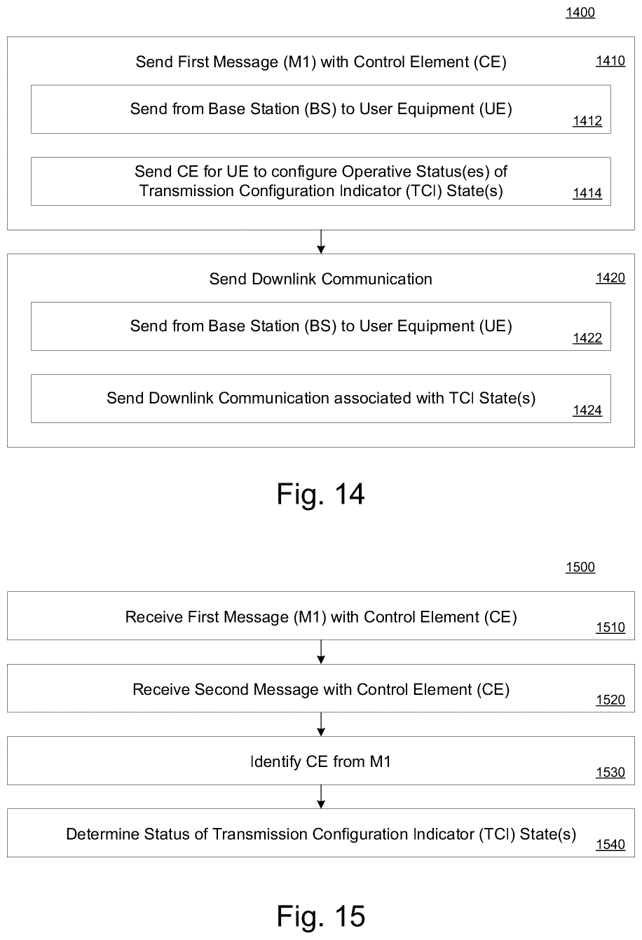

FIG. 14 illustrates a third method of indicating TCI states under multi-TRP operation, in accordance with present implementations. At least one of the systems 100 and 200 can perform method 1400 according to present implementations. The method 1400 can begin at step 1410.

At step 1410, the method can send a first message with a control element. Step 1410 can include at least one of steps 1412 and 1414. At step 1412, the method can send the first message from the BS to the UE. At step 1414, the method can send the control element for at least one UE to configure at least one operative status of at least one TCI state. The method 1400 can then continue to step 1420.

At step 1420, the method can send at least one downlink communication. Step 1420 can include at least one of steps 1422 and 1424. At step 1422, the method can send the downlink communication from the BS to the UE. At step 1424, the method can send a downlink communication associated with at least one TCI state. The method 1400 can end at step 1420.

FIG. 15 illustrates a fourth method of indicating TCI states under multi-TRP operation, in accordance with present implementations. At least one of the systems 100 and 200 can perform method 1500 according to present implementations. The method 1500 can begin at step 1510. At step 1510, the method can receive a first message including a control element. The method 1500 can then continue to step 1520. At step 1520, the method can receive a second message with a control element. The method 1500 can then continue to step 1530. At step 1530, the method can identify the control element from the first message. The method 1500 can then continue to step 1540. At step 1540, the method can determine at least one status of at least one TCI states. The method 1500 can end at step 1540.

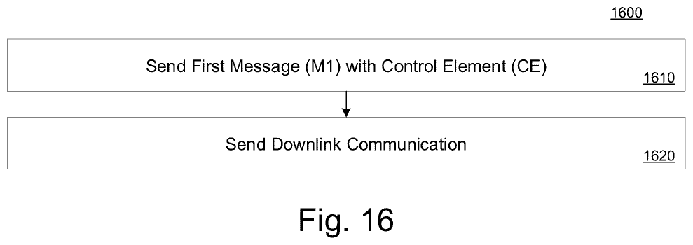

FIG. 16 illustrates a fifth method of indicating TCI states under multi-TRP operation, in accordance with present implementations. At least one of the systems 100 and 200 can perform method 1600 according to present implementations. The method 1600 can begin at step 1610. At step 1610, the method can send a first message with a control element. The method 1600 can then continue to step 1620. At step 1620, the method can send at least one downlink communication. The method 1600 can end at step 1620.

The herein described subject matter sometimes illustrates different components contained within, or connected with, different other components. It is to be understood that such depicted architectures can be illustrative, and that in fact many other architectures can be implemented which achieve the same functionality. In a conceptual sense, any arrangement of components to achieve the same functionality can be effectively “associated” such that the desired functionality can be achieved. Hence, any two components herein combined to achieve a particular functionality can be seen as “associated with” each other such that the desired functionality can be achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but can be not limited to physically mateable and/or physically interacting components and/or wirelessly interactable and/or wirelessly interacting components and/or logically interacting and/or logically interactable components.

With respect to the use of plural and/or singular terms herein, those having skill in the art can translate from the plural to the singular and/or from the singular to the plural as can be appropriate to the context and/or application. The various singular/plural permutations may be expressly set forth herein for sake of clarity.

It will be understood by those within the art that, in general, terms used herein, and especially in the appended claims (e.g., bodies of the appended claims) can be generally intended as “open” terms (e.g., the term “including” should be interpreted as “including but not limited to,” the term “having” should be interpreted as “having at least,” the term “includes” should be interpreted as “includes but can be not limited to,” etc.).

Although the figures and description may illustrate a specific order of method steps, the order of such steps may differ from what can be depicted and described, unless specified differently above. Also, two or more steps may be performed concurrently or with partial concurrence, unless specified differently above. Such variation may depend, for example, on the software and hardware systems chosen and on designer choice. All such variations can be within the scope of the disclosure. Likewise, software implementations of the described methods could be accomplished with standard programming techniques with rule-based logic and other logic to accomplish the various connection steps, processing steps, comparison steps, and decision steps.

It will be further understood by those within the art that if a specific number of an introduced claim recitation can be intended, such an intent will be explicitly recited in the claim, and in the absence of such recitation, no such intent can be present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation can be explicitly recited, those skilled in the art will recognize that such recitation should typically be interpreted to mean at least the recited number (e.g., the bare recitation of “two recitations,” without other modifiers, typically means at least two recitations, or two or more recitations).

Furthermore, in those instances where a convention analogous to “at least one of A, B, and C, etc.” can be used, in general such a construction can be intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” can be used, in general, such a construction can be intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

Further, unless otherwise noted, the use of the words “approximate,” “about,” “around,” “substantially,” etc., mean plus or minus ten percent.

The foregoing description of illustrative implementations has been presented for purposes of illustration and of description. It can be not intended to be exhaustive or limiting with respect to the precise form disclosed, and modifications and variations can be possible in light of the above teachings or may be acquired from practice of the disclosed implementations. It can be intended that the scope of the invention be defined by the claims appended hereto and their equivalents.

1. A wireless communication method, comprising:
receiving, by a wireless communication device from a wireless communication node, a first message including a control element that selectively includes a field having an indicator or a field having an index; and
determining, by the wireless communication device, a configured operative status of each of one or more Transmission Configuration Indicator (TCI) states for a downlink communication, according to the control element.

2. The method of claim 1, wherein the downlink communication includes at least one of a Physical Downlink Shared Channel (PDSCH) reception, a Physical Downlink Control Channel (PDCCH) reception, a Physical Downlink Shared Channel (PDSCH) reception, a Semi-Persistent (SP) Channel State Information Reference Signal (CSI-RS), a Semi-Persistent (SP) Channel State Information Interference Measurement (CSI-IM), or an aperiodic Channel State Information Reference Signal (CSI-RS).

3. The method of claim 1, further comprising identifying, by the wireless communication device, the control element from the first message based on at least one of a Medium Access Control (MAC) subheader or an Extended Logic Channel Indicator (eLCID).

4. The method of claim 1, wherein the control element includes a first field indicating an identity of a Serving Cell to which the control element applies.

5. The method of claim 1, wherein the control element includes a second field indicating a Bandwidth Part Indicator (BWP ID).

6. The method of claim 1, wherein the control element includes one or more third fields respectively indicating the operative statuses of the TCI states.

7. The method of claim 6, wherein the one or more third fields form a bitmap.

8. The method of claim 6, wherein the one or more third fields form one or more codepoints.

9. The method of claim 1, wherein the control element selectively includes a fourth field indicating a Control Resource Set Pool Indicator (CORESET Pool ID).

10. The method of claim 1, wherein the control element selectively includes a fifth field having an index indicating a single non-serving cell information unit with which a subset of the one or more TCI states, being activated, can be associated.

11. The method of claim 10, wherein the single non-serving cell information unit can be associated with a cell configured with a different Physical Cell Indicator (PCI) from a serving cell.

12. The method of claim 10, further comprising receiving, by the wireless communication device, second message including a Radio Resource Control (RRC) signaling that configures the single non-serving cell information unit, wherein the single non-serving cell information unit can be specific to a Synchronization Signal Block (SSB) of an RRC Information Element (IE).

13. The method of claim 10, wherein the index further indicates a PCI additional to a PCI of a serving cell and associated with the single non-serving cell information unit.

14. The method of claim 10, wherein the fifth field can be present in the control element when the non-serving cell information unit can be configured with the index, and wherein the fifth field can be specific to the configured index in the non-serving cell information unit.

15. The method of claim 12, wherein a number of the activated TCI states associated with the non-serving cell information unit corresponds to the additional PCI, and depends on User Equipment (UE) capability of the wireless communication device.

16. The method of claim 15, wherein the UE is capable of supporting inter-cell multi transmission and reception point (MTRP) operation, in response to the UE reporting the UE capability associated with a maximum number.

17. The method of claim 15, wherein the UE is not capable of supporting inter-cell multi transmission and reception point (MTRP) operation, in response to the UE forgoing reporting the UE capability associated with a maximum number.

18. A wireless communication method, comprising:
sending, by a wireless communication node to a wireless communication device, a first message including a control element; and
sending, by the wireless communication node to the wireless communication device, a downlink communication;
wherein the control element can be used by the wireless communication device to determine a configured operative status of each of one or more Transmission Configuration Indicator (TCI) states for the downlink communication.

19. A wireless communication device, comprising:
at least one processor configured to:
receive, via a receiver from a wireless communication node, a first message including a control element that selectively includes a field having an indicator or a field having an index; and
determine a configured operative status of each of one or more Transmission Configuration Indicator (TCI) states for a downlink communication, according to the control element.

20. A wireless communication node, comprising:
at least one processor configured to:
send, via a transmitter to a wireless communication device, a first message including a control element; and
send, via the transmitter to the wireless communication device, a downlink communication,
wherein the control element can be used by the wireless communication device to determine a configured operative status of each of one or more Transmission Configuration Indicator (TCI) states for the downlink communication.
